(19) United States
(12) Patent Application Publication
(10) Pub. No.: US 2010/0266185 A1
(43) Pub. Date: Oct. 21, 2010

(54) MALIGNANT TISSUE RECOGNITION MODEL FOR THE PROSTATE

(75) Inventor: Lukasz Matulewicz, New York, NY (US)

Correspondence Address: DITTHAVONG MORI & STEINER, P.C, 918 PRINCE STREET, ALEXANDRIA, VA, 22314, US

(73) Assignee: Sloan Kettering Institute of Cancer, New York, NY (US)

(21) Appl. No.: 12/764,568

(22) Filed: Apr. 21, 2010

Related U.S. Application Data
(60) Provisional application No. 61/171,451, filed on Apr. 21, 2009.

(51) Int. Cl. G06K 9/00

(52) U.S. Cl. 382/131

(57) ABSTRACT

Techniques for automated classification of ¹H-MRSI voxels of the human prostate to draw a radiologist's attention include receiving spectra for voxels from a scan of a human prostate, and segregating the voxels by anatomical zone of the prostate where voxels would be expected to have similar spectral signatures. In some embodiments, the whole prostate gland is a single zone. The spectrum of each voxel in the zone is provided as input to a neural network trained to give expert classification in the zone for a training set. Each voxel is automatically classified based on output from the neural network. In an alternative embodiment, the amplitudes are determined of principal components derived from all spectra in a training set in the zone. Those amplitudes are provided as input to a functional form fit to the expert classification. Each voxel is automatically classified based on output from the functional form.

### CROSS-REFERENCE TO RELATED APPLICATIONS

This application claims benefit of Provisional Appln. 61/171,451, filed Apr. 21, 2009, the entire contents of which are hereby incorporated by reference as if fully set forth herein, under 35 U.S.C. 119(e).

### STATEMENT OF GOVERNMENTAL INTEREST

This invention was made in part with Government support under Contract No. R01-CA076423 awarded by the National Institutes of Health (NIH) National Cancer Institute (NCI) The Government has certain rights in the invention.

### BACKGROUND

Malignant tissue in the human prostate is known to have a unique type of signature expressed in hydrogen atom magnetic resonance spectroscopic imaging (¹H-MRSI) in which a spectrum is obtained for every voxel in a three-dimensional volume encompassing the prostate in an endorectal scan. A voxel is a volume element for which at least one value is available representing a physical property at a corresponding location in the subject of the scan. Currently, interpretation of MRSI data requires a trained physicist who performs a visual inspection of the data. This is somewhat time-consuming, requires expertise, and is subject to inter-observer variability. The expert physicist must currently parse through over one-hundred spectra per scan for one patient to identify the voxels with suspicious spectra indicative of the malignant tissue. Therefore this valuable diagnostic technique is not as widely used as would be beneficial to public health.

### SOME EXAMPLE EMBODIMENTS

Therefore, there is a need for automated classification of ¹H-MRSI voxels to draw a radiologist's attention to the most important portions of a scan, whether expert in MRSI signatures or not.

According to one embodiment, a method includes receiving spectra for voxels from a ¹H-MRSI scan of a human prostate, segregating the voxels by prostate anatomical zone, providing the spectrum of each voxel in the zone as input to a neural network trained to give expert classification in the zone for a training set, and automatically classifying each voxel based on output from the neural network.

According to another embodiment, a method includes receiving spectra for voxels from a ¹H-MRSI scan of a human prostate, segregating the voxels by prostate anatomical zone, determining the amplitude of principal components derived from all spectra in the zone, providing those amplitudes as input to a functional form fit to the expert classification in the zone for the training set, and automatically classifying each voxel based on output from the functional form.

In other embodiments, an apparatus, or logic encoded in one or more tangible media, or instructions encoded on one or more computer-readable media is configured to perform one or more steps of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings in which:

FIG. 1A is a diagram that illustrates an example magnetic resonance imaging (MRI) image of a prostate gland and corresponding magnetic resonance spectroscopic imaging (MRSI) voxels for classifying, according to an embodiment;

FIG. 1B is a graph that illustrates example magnetic resonance spectra for three example MSRI voxels, according to an embodiment;

FIG. 2A is diagram that illustrates an example MRI image, example MRSI voxels and multiple example prostate anatomical zones, according to an embodiment;

FIG. 2B is a diagram that illustrates an example MRI image and MRSI voxels classified by an experienced spectroscopist, according to an embodiment;

FIG. 2C is a diagram that illustrates an example histology section and lesions indicative of a tumor identified by an expert;

FIG. 2D is a graph of example mean and one standard deviation variance of spectral amplitudes at 256 frequencies in a frequency band from 4.3 ppm to 0.4 ppm for voxels in a peripheral zone of a prostate gland, according to an embodiment;

FIG. 2E is a graph as in FIG. 2D but for voxels in a transition zone of a prostate gland, according to an embodiment;

FIG. 2F is a graph as in FIG. 2D but for voxels in a periurethral zone of a prostate gland, according to an embodiment;

FIG. 2G is a graph as in FIG. 2D but for voxels outside of a prostate gland, according to an embodiment;

FIG. 2H is a graph as in FIG. 2D but for voxels that include a prostate lesion indicative of a tumor, according to an embodiment;

FIG. 3 is a diagram that illustrates modules of a system for classification of voxels as suspicious for malignant prostate tissue, according to one embodiment;

FIG. 4A and FIG. 4B constitute a flowchart that illustrates an example process for deriving data used by one or more modules of the system, according to one embodiment;

FIG. 5A is a diagram that illustrates example principal components and corresponding amplitudes, according to an embodiment;

FIG. 5B Is a graph that illustrates importance of example frequencies in an MSRI spectrum for classifying a voxel, according to an embodiment;

FIG. 5C is a graph that illustrates example empirical orthogonal functions used as principal components, according to another embodiment;

FIG. 5D is a block diagram that illustrates example use of a functional form to classify a voxel based on amplitudes of principal components, according to an embodiment;

FIG. 5E is a graph that illustrates example functional form for classifying voxels, according to an embodiment;

FIG. 6A is a flowchart that illustrates an example process for classifying MRSI voxels using principal components, according to an embodiment;

FIG. 6B is a flowchart that illustrates an example process for segregating voxels by anatomical zone, according to an embodiment;

FIG. 7 is a graph that illustrates an example alignment of peaks in multiple MRSI spectra, according to an embodiment;

FIG. 8A is a graph that illustrates example high signal to noise ratio (SNR) MRSI spectra, according to an embodiment;

FIG. 8B is a graph that illustrates example low SNR MRSI spectra, according to an embodiment;

FIG. 9 is a diagram that illustrates an example artificial neural network (ANN), according to an embodiment;

FIG. 10A through FIG. 10D are graphs that illustrate example effects of nodes in a hidden layer of a neural network on successful classification of voxels, according to various embodiments;

FIG. 11 is a flowchart that illustrates an example process for classifying MRSI voxels using an artificial neural network, according to an embodiment; and

FIG. 12 is a diagram of hardware that can be used to implement an embodiment of the invention.

### DETAILED DESCRIPTION OF EXAMPLE EMBODIMENTS

A method, apparatus, and software are disclosed for classification of MRSI voxels as positive or negative for malignant prostate tissue. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

An example embodiment is described in this section. Alternative or more detailed embodiments are described in later sections. In various embodiments, magnetic resonance spectroscopy data undergoes a purely objective principal component analysis or a neural network is developed, or both. In some embodiments, a human anatomy database is incorporated which has been generated by a specialized genitourinary radiologist. In some embodiments, factors specific to an examination, such as lesion volume and degree of metabolic abnormality, data quality, endorectal coil sensitivity profile, periurethral location and zonal location are incorporated. In some embodiments, accuracy is assessed by comparison to assessments by an expert medical spectroscopic physicist. In some embodiments, accuracy is assessed by comparison to whole-mount, step-section pathology.

The illustrated embodiments automate the process of spectral interpretation. Such embodiments could be used to reduce the interpretation time by indicating suspicious regions of a prostate for the physicist/spectroscopist or pathologist to inspect. In the many facilities where a trained physicist is not available, an embodiment could be used to assist the radiologist in interpreting the MRSI data. In some embodiments, the automated process outperforms the spectroscopist and indicates tumor positive voxels with fewer false positives.

Nuclear magnetic resonance (NMR) studies magnetic nuclei by aligning them with an applied constant magnetic field (B₀) and perturbing this alignment using an alternating magnetic field (B₁), orthogonal to the constant magnetic field. The resulting response to the perturbing magnetic field is the phenomenon that is exploited in magnetic resonance spectroscopy (MRS) and magnetic resonance imaging (MRI).

The elementary particles, neutrons and protons, composing an atomic nucleus, have the intrinsic quantum mechanical property of spin. The overall spin of the nucleus is determined by the spin quantum number I. If the number of both the protons and neutrons in a given isotope are even, then I=0. In other cases, however, the overall spin is non-zero. A non-zero spin is associated with a non-zero magnetic moment, μ, as given by Equation 1a.

μ=γ I (1a)

where the proportionality constant, γ, is the gyromagnetic ratio. It is this magnetic moment that is exploited in NMR. For example, nuclei that have a spin of one-half, like Hydrogen nuclei (¹H), a single proton, have two possible spin states (also referred to as up and down, respectively). The energies of these states are the same. Hence the populations of the two states (i.e. number of atoms in the two states) will be approximately equal at thermal equilibrium. If a nucleus is placed in a magnetic field, however, the interaction between the nuclear magnetic moment and the external magnetic field means the two states no longer have the same energy. The energy difference between the two states is given by Equation 1b.

ΔE=γ B₀ (1b)

where is Planck's reduced constant. Resonant absorption will occur when electromagnetic radiation of the correct frequency to match this energy difference is applied. The energy of photons of electromagnetic radiation is given by Equation 2.

E=h f (2)

where f is the frequency of the electromagnetic radiation and h=2π . Thus, absorption will occur when the frequency is given by Equation 3.

f=γ B₀/(2π) (3)

The NMR frequency f is shifted by the ‘shielding’ effect of the surrounding electrons. In general, this electronic shielding reduces the magnetic field at the nucleus (which is what determines the NMR frequency). As a result, the energy gap is reduced, and the frequency required to achieve resonance is also reduced. This shift of the NMR frequency due to the chemical environment is called the chemical shift, and it explains why NMR is a direct probe of chemical structure. The chemical shift in absolute terms is defined by the frequency of the resonance expressed with reference to a standard compound which is defined to be at 0. The scale is made more manageable by expressing it in parts per million (ppm).

Applying a short electromagnetic pulse in the radio frequency (RF) range to a set of nuclear spins simultaneously excites all the NMR transitions. In terms of the net magnetization vector, this corresponds to tilting the magnetization vector away from its equilibrium position (aligned along the external magnetic field, B₀). The out-of-equilibrium magnetization vector precesses about the external magnetic field at the NMR frequency of the spins. This oscillating magnetization induces a current in a nearby pickup coil acting as a radio frequency (RF) receiver, creating an electrical signal oscillating at the NMR frequency. A portion of this time domain signal (intensity vs. time) is known as the free induction decay (FID) and contains the sum of the NMR responses from all the excited spins. In order to obtain the frequency-domain NMR spectrum (intensity vs. frequency) for magnetic resonance spectroscopy (MRS) and MRS imaging (MRSI), this time-domain signal is Fourier transformed, as is well known in the art.

In addition to the spectra obtained from a MRSI scan, a higher spatial resolution magnetic resonance imagery (MRI) image can also be generated without spectral information from the same scan. MRI spatial resolution provides imaging volume elements (voxels) that are much smaller than a typical MRS voxel. For example, an MRSI voxel is approximately three orders of magnitude larger than a high resolution MRI voxel (e.g., an MRSI voxel is on the order of cubic centimeters , cm³, and a MRI voxel is on the order of cubic millimeters, mm³, where 1 mm=10⁻³ meters and 1 cm=10⁻² meters).

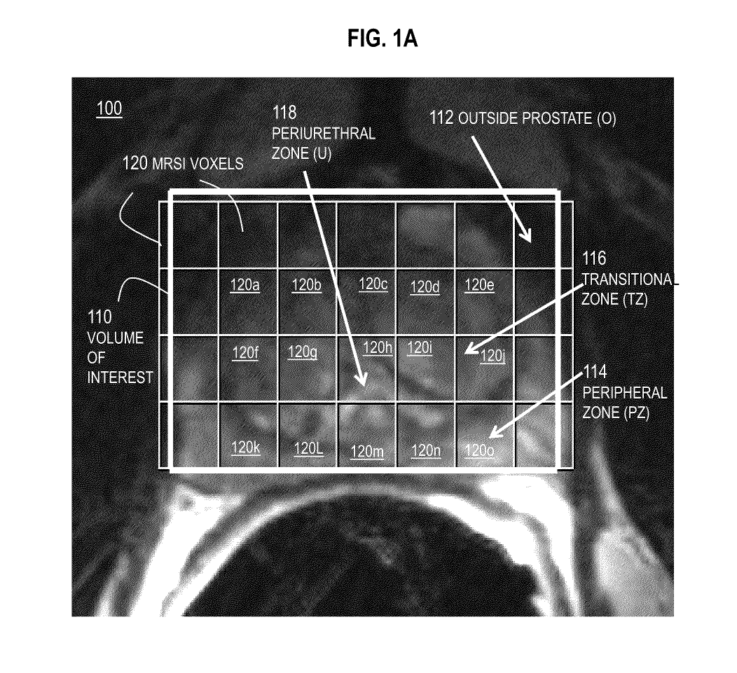

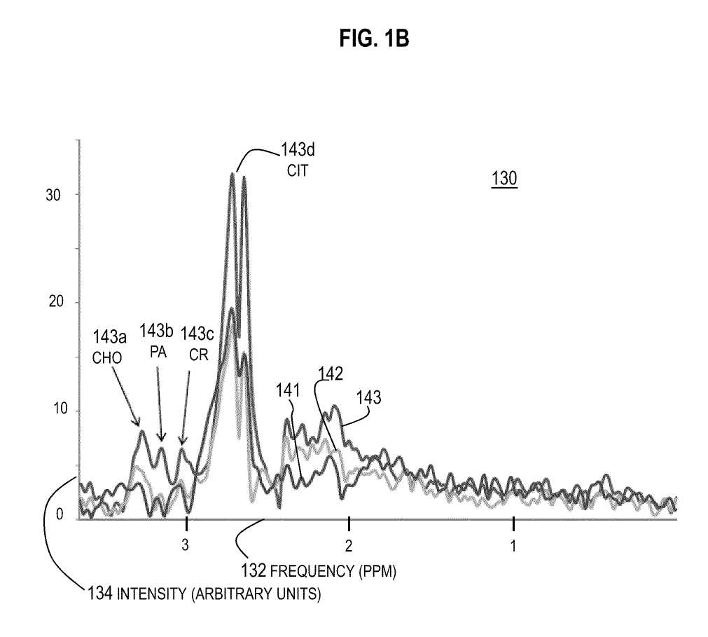

FIG. 1A is a diagram that illustrates an example magnetic resonance imaging (MRI) image 100 of a prostate gland and corresponding magnetic resonance spectroscopic imaging (MRSI) voxels 120 for classifying, according to an embodiment. The MRI and MSR data depicted in FIG. 1A and other figures were collected from one or more of a data base of up to 18 human male subjects, as described in more detail in a later section. The MRI image 100 comprises 256 by 192 high resolution MRI voxels; and shows detail related to tissues in the subject and includes prostate gland tissue in a volume of interest 110. Within the image 100, some high resolution MRI voxels depict volumes in a zone 112 outside the prostate, abbreviated as O, while other high resolution MRI voxels depict volumes inside the prostate. Several prostate anatomical zones are evident. In some embodiments, the voxels within the prostate gland are further segregated into a zone 118 near the urethra (called the periurethral zone 118, abbreviated as U), a zone 114 along the lower periphery of the prostate gland (called the peripheral zone 114, abbreviated as PZ), and a zone 116 of the remaining prostate gland (called the transition zone 116, abbreviated as TZ).

The much lower resolution MRSI voxels 120 encompass the prostate gland in the depicted section. Each MRSI voxel 120 is associated with a MRS spectrum of intensities at 512 resolved frequencies. Each MRSI voxel 120 can be associated with one or more of the prostate anatomical zones. For example, MRSI voxels 120a, 120b, 120c, 120d, 120e, 120f, 120g, 120j are associated with the transition zone (TZ) 116; MRSI voxels 120h, 120L, 120m and 120n are associated with the periurethral zone (U) 118; and MRSI voxels 120k and 120o are associated with the peripheral zone (PZ) 114. In some embodiments, at least some MRSI voxels are each associated with a percentage of each of two or more zones.

FIG. 1B is a graph 130 that illustrates example magnetic resonance spectra 141, 142 and 143 for three example MSRI voxels, according to an embodiment. The horizontal axis 132 is frequency shift in parts per million (ppm) decreasing from about 4 on the left to about 0 on the right (t). The vertical axis 134 is resonance intensity in arbitrary units, increasing from zero at the bottom to over 30 at the top. Prevalent chemical species cause well known resonance peaks in the frequency shift spectrum, such as peak 143a associated with choline (CHO) at 3.2 ppm, peak 143b associated with polyamines (PA) at 3.1 ppm a peak 143c associated with creatine and phosphocreatine (CR) at 3.0 ppm, and a peak 143d associated with citrate (CIT) at 2.6 ppm, all in spectrum 143. Similar peaks appear to a lesser degree in spectra 141 and 142.

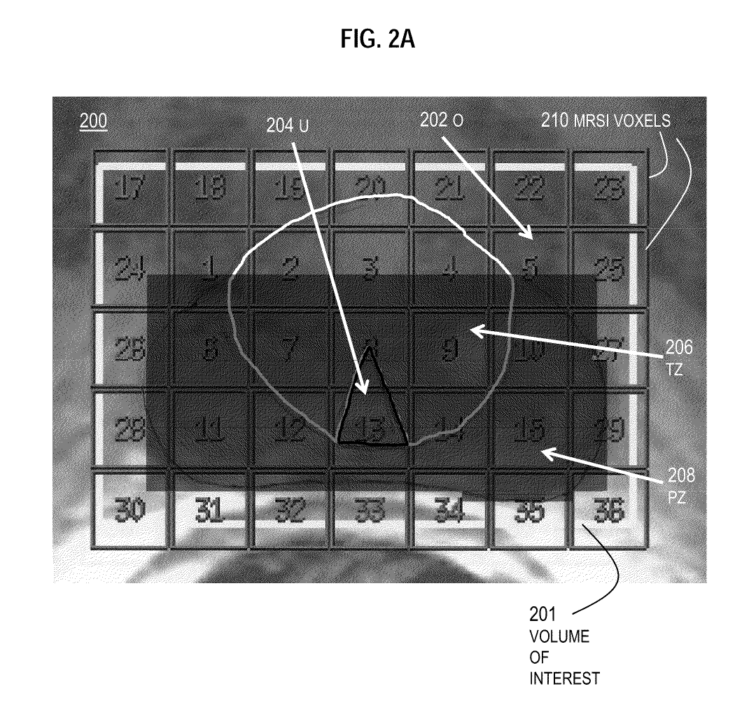

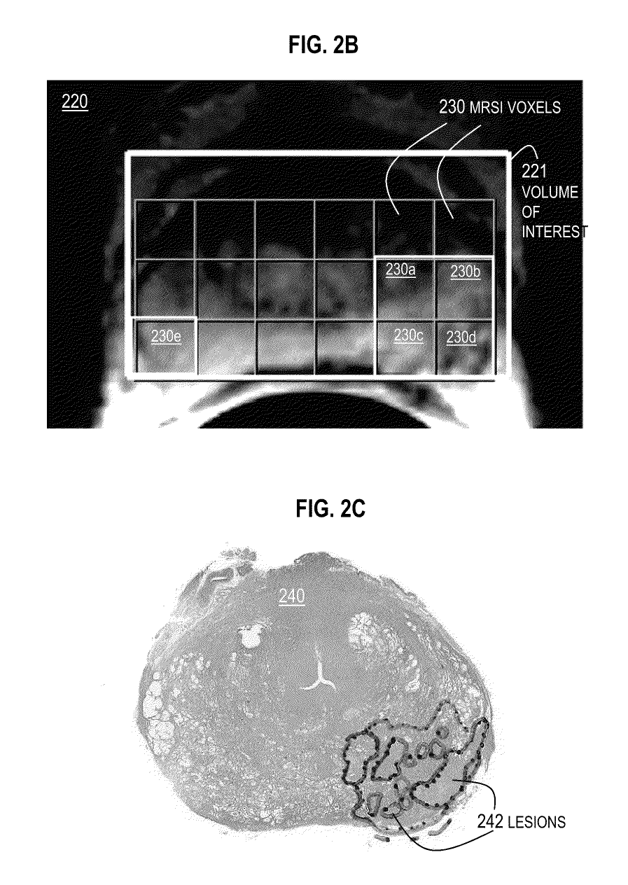

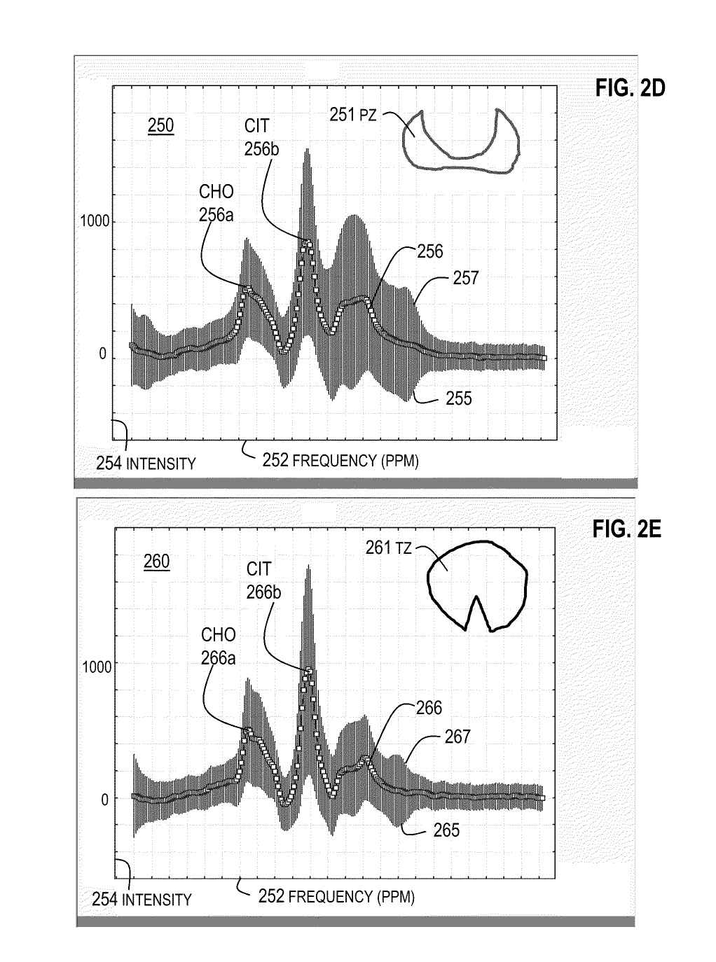

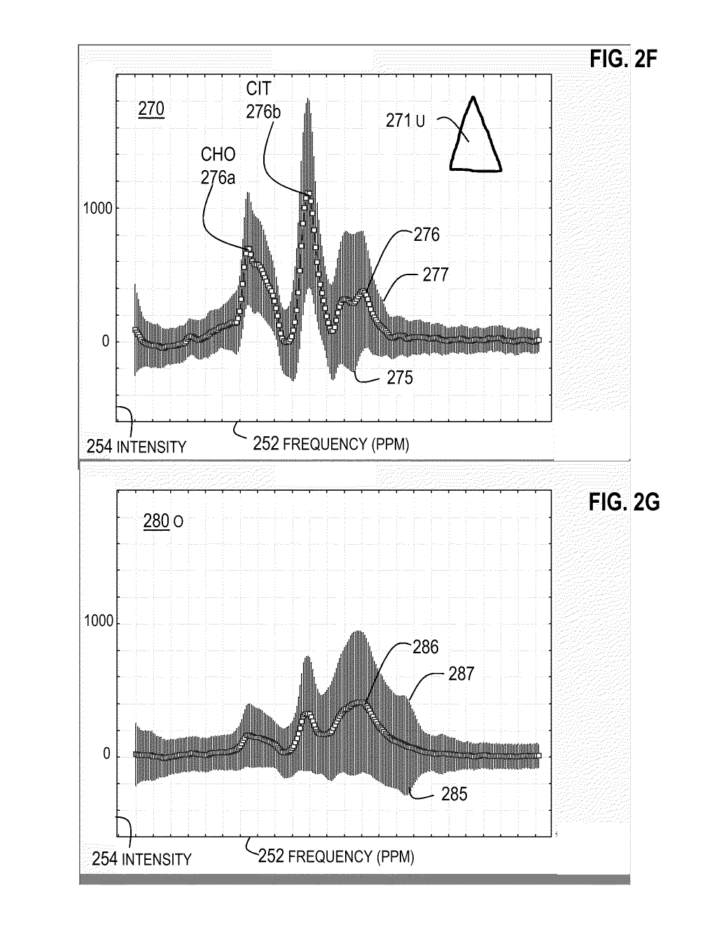

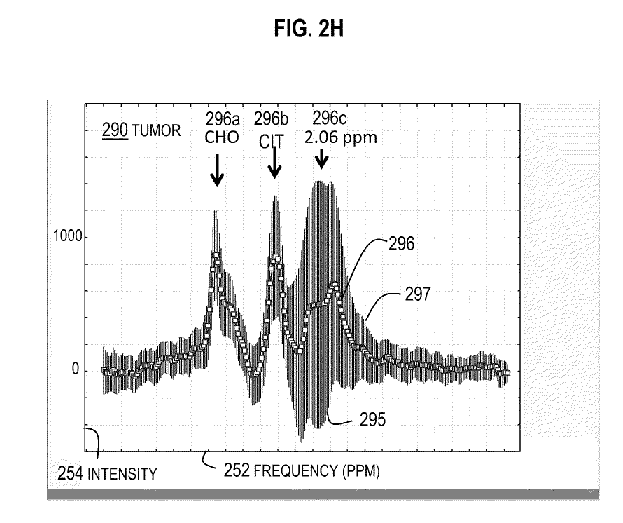

FIG. 2A is diagram that illustrates an example MRI image 200, example MRSI voxels 210 and multiple example prostate anatomical zones, according to an embodiment. The MRI image 200 comprises 256 by 192 high resolution MRI voxels; and shows detail related to tissues in the subject and includes prostate gland tissue in a volume of interest 201. In the illustrated embodiment, the radiologist has indicated the borders of the prostate anatomical zones U 204, TZ 206 and PZ 208. Voxels outside all three zones are in zone O 202. Thirty five MRSI voxels 210 that span the volume of interest 201 are numbered 1 through 36 (skipping number 16). In some embodiments, the MRI voxels 210 are associated with one or more of the prostate anatomical zones O 202, U 204, TZ 206 and PZ 208. For example, MRSI voxel 210 number 10 is associated with 80% PZ and 20% TZ.]

FIG. 2B is a diagram that illustrates an example MRI image 220 and MRSI voxels 230 classified by an experienced spectroscopist, according to an embodiment. The MRI image 220 comprises 256 by 192 high resolution MRI voxels; and shows detail related to tissues in the subject and includes prostate gland tissue in a volume of interest 121. In the illustrated embodiment, an experienced physicist/spectroscopist has indicated MRSI voxels 230a, 230b, 230c, 230d and 230e are suspected of including tumors (in some embodiments, such voxels are included as tumor positive voxels and used to train one or more models).

FIG. 2C is a diagram that illustrates an example histology section 240 and lesions 242 indicative of a tumor identified by an expert pathologist. Such lesions indicate prostate tumors. The section 240 is formed by staining a slice of tissue from a portion of the prostate that corresponds to the image 220. The position of the actual lesions 242 correspond to the MRSI voxels 230a, 230b, 230c and 230d marked by the physicist/spectroscopist as suspicious. However, the MRSI voxel 230e corresponds to a portion of the prostate that does not show lesions in the section 240. Therefore tumor suspicious voxel 230e is a false positive classification by the physicist/spectroscopist. In some embodiments, one or more models are trained to exclude the false positive voxel 230e from tumor positive voxels in one or more training sets and test sets of MRSI voxels.

A data base of MRI and MRSI data and histology sections were collected to train and test models that automatically classify voxels as tumor positive or tumor negative. Different embodiments of the models were developed using different portions of the data set. At its greatest extent, the data base was collected from 18 men with prostate cancer. This group had an age range from 49 to 82 years with a median age of 62 years. This group had a mean biopsy Gleason grade of 7. To be included in the data set, the cancer patient had to have at least one MRSI voxel that was rated by a physicist/spectroscopist as suspicious of including a tumor, at least one lesion indicating a tumor on a whole-mount histopathological map, and no prior hormonal or radiation treatment.

The 3D ¹H-MRSI examinations were performed on a 1.5-Tesla whole-body unit (Signa Horizon from GE Medical Systems of General Electric Healthcare of Waukesha, Wis.) with an endorectal coil (from Medrad of Pittsburgh, Pa.) and PROSE acquisition package (GE Medical Systems) in a location prescribed by T2-weighted fast spin-echo images {4400/(effective) 102; echo train length, 12; section thickness, 3 millimeters (mm); intersection gap, 0 mm; field of view, 14 centimeters (cm); matrix, 256×192}. The spectroscopic acquisition parameters were as follows: PRESS voxel selection, 1000/130 milliseconds (m, 1 ms=10⁻³ seconds) [TR/TE]; one average; spectral width, 1250 Hertz (Hz, 1 Hz=1 cycle per second); number of points, 512; field of view, 11 cm×5.5 cm×5.5 cm; and 16×8×8 phase encoding steps. Each MRSI voxel represented a patient volume of 0.69 cm×0.69 cm×0.34 cm. Spectral data were automatically processed by Functool software (GE Medical Systems). Some or all of the data in GE format within the range 4.3 ppm to 0.4 ppm (256 points) were used; and real (magnitude) spectra were exported for further analysis.

In each patient, all voxels within the PRESS excitation volume were labeled as healthy or suspicious by an experienced spectroscopist according to established decision rules based on the resonances of total choline (CHO) at 3.2 ppm, creatine/phosphocreatine (CR) at 3.0 ppm, polyamines (PA) at 3.1 ppm and citrate (CIT) at 2.6 ppm.

FIG. 2D is a graph 250 of example mean and one standard deviation variance of spectral amplitudes at 256 frequencies in a frequency band from 4.3 ppm to 0.39 ppm for voxels in a peripheral zone of a prostate gland, according to an embodiment. For convenience an outline 251 of a typical PZ is inserted on the graph 250. The horizontal axis 252 is frequency shift in parts per million (ppm) decreasing from over 4.3 on the left to under 0.39 on the right; and, the vertical axis 254 is intensity in arbitrary units. In some embodiments, the features rely on relative intensities of different peaks in a single spectrum and no normalization of intensity is performed among spectra from different voxels. The open circles 256 represent the mean intensity over 1139 voxels considered to have a greater percentage in the peripheral zone than in a transition zone for a data set comprising all 18 patients in the complete data base. The vertical bars above 257 and below 255 each open circle 256 represent one standard deviation above and below the mean, respectively. A CHO peak 256a and CIT peak 256b are evident in the mean and standard deviations.

FIG. 2E is a graph 260 as in FIG. 2D but for voxels in a transition zone of a prostate gland, according to an embodiment. For convenience an outline 261 of a typical TZ is inserted on the graph 260. The horizontal axis 252 and vertical axis 254 are as described above. The open circles 266 represent the mean intensity over 1457 voxels considered to have a greater percentage in the transition zone than in the peripheral zone for the data set comprising all 18 patients. The vertical bars above 267 and below 265 each open circle 266 represent one standard deviation above and below the mean, respectively. A CHO peak 266a and CIT peak 266b are evident in the mean and standard deviations.

FIG. 2F is a graph 270 as in FIG. 2D but for voxels in a periurethral zone of a prostate gland, according to an embodiment. For convenience an outline 271 of a typical U is inserted on the graph 270. The horizontal axis 252 and vertical axis 254 are as described above. The open circles 276 represent the mean intensity over 389 voxels considered to be 10% or more in the periurethral zone U for the data set comprising all 18 patients. The vertical bars above 277 and below 275 each open circle 276 represents one standard deviation above and below the mean, respectively. A CHO peak 276a and CIT peak 276b are evident in the mean and standard deviations.

FIG. 2G is a graph 280 as in FIG. 2D but for voxels outside of a prostate gland, according to an embodiment. The horizontal axis 252 and vertical axis 254 are as described above. The open circles 286 represent the mean intensity over 2158 voxels considered to be 60% or more in the outside prostate zone O for the data set comprising all 18 patients. The vertical bars above 287 and below 285 each open circle 286 represents one standard deviation above and below the mean, respectively. Weak CHO peak and weak CIT peak are evident in the mean and upper standard deviation but not below.

FIG. 2H is a graph 290 as in FIG. 2D but for voxels that include a prostate lesion indicative of a tumor, according to an embodiment. The horizontal axis 252 and vertical axis 254 are as described above. The open circles 296 represent the mean intensity over 86 voxels that correspond to prostate portions that include lesions determined in histology sections for the same ten patients. The vertical bars above 297 and below 295 each open circle 296 represents one standard deviation above and below the mean, respectively. A CHO peak 296a and relatively weak CIT peak 296b are evident in the mean and standard deviations, as well as a strong peak at 2.06 ppm in the upper standard deviation 297. As expected, the most characteristic marker of the tumor is CHO peak 296a. However, the same signal with similar intensity can be observed in periurethral zone (peak 276a in FIG. 2F) which may be due to glycerophosphocholine (GPC) in seminal fluid. Tumor tissue spectra also reveal a relatively elevated unidentified compound at 2.06 ppm (peak 296c); however, this region is in the transition band of the spectral-spatial excitation pulses; and thus a chemical origin is uncertain.

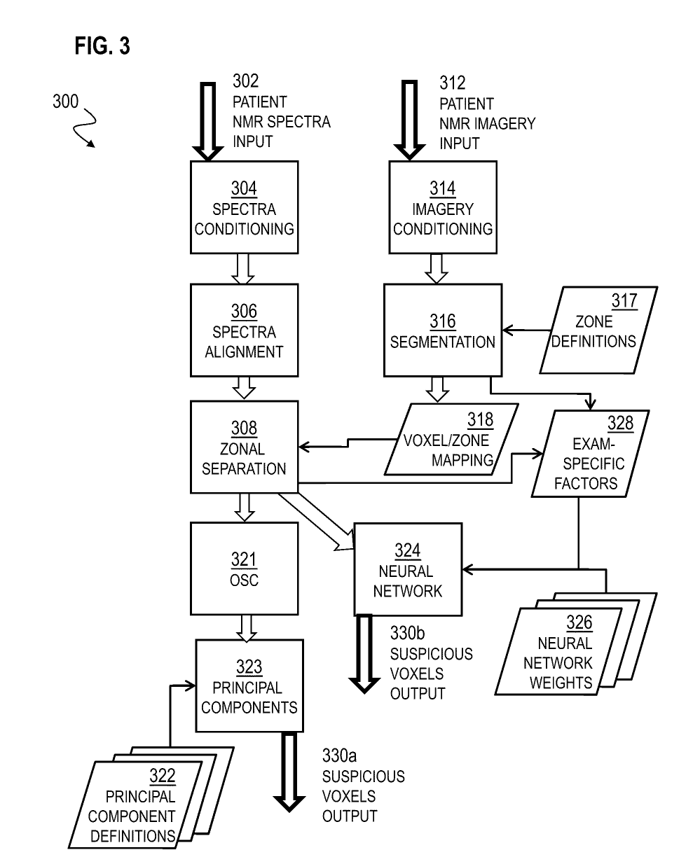

FIG. 3 is a diagram that illustrates modules of one or more systems 300 for classification of voxels as suspicious for malignant prostate tissue or otherwise tumor positive, according to one or more embodiments. The system 300 classifies the voxels in one scan of one patient as suspicious or not or tumor positive or not. The system includes an input port 302 for data indicating nuclear magnetic resonance (NMR) spectra (e.g., 1H-MRSI spectra) from one scan and an input port 312 for data indicating NMR imagery (e.g., MRI intensity values for the same scan). In the illustrated embodiment, the system 300 also includes spectra conditioning module 304, spectra alignment module 306, zonal separation module 308, OSC module 321, principal components module 323 and artificial neural network module 324. The illustrated embodiment also includes an imagery conditioning module 314 and a segmentation module 316. These modules are supported by model data in one or more data structures, including zone definitions data structure 317, voxel-to-zone mapping data structure 318, principal component definitions data structure 322, neural network weights data structure 326 and exam-specific factors data structure 328.

Although a particular set of modules and data structures are shown in FIG. 3 for purposes of illustration, in various other embodiments more or fewer modules and data structures are involved. Furthermore, although modules and data structures are depicted, in FIG. 3 and following drawings, as particular blocks in a particular arrangement on a single platform or node for purposes of illustration, in other embodiments each process or data structure, or portions thereof, may be separated or combined or arranged in some other fashion on one or more nodes of a communications network.

The spectra conditioning module 304 is configured to perform any preprocessing on MRSI spectra that is considered desirable, such as time series padding, frequency bin averaging or correcting amplitudes for windowing performed for the Fourier transforms. Any conditioning of MRSI spectra known in the art may be performed by module 304, such as the Functool software identified above. Similarly, the imagery conditioning module 314 is configured to perform any conditioning of MRI images known in the art.

The spectra alignment module 306 is configured to align the frequency bins for all spectra in the input scan so that peaks can be properly characterized by the principal components or properly input to the neural network or both.

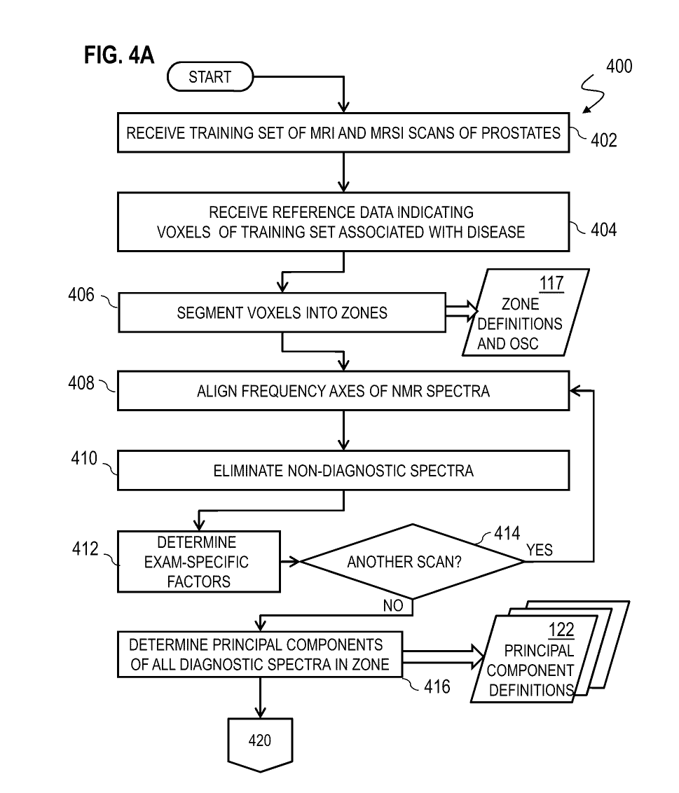

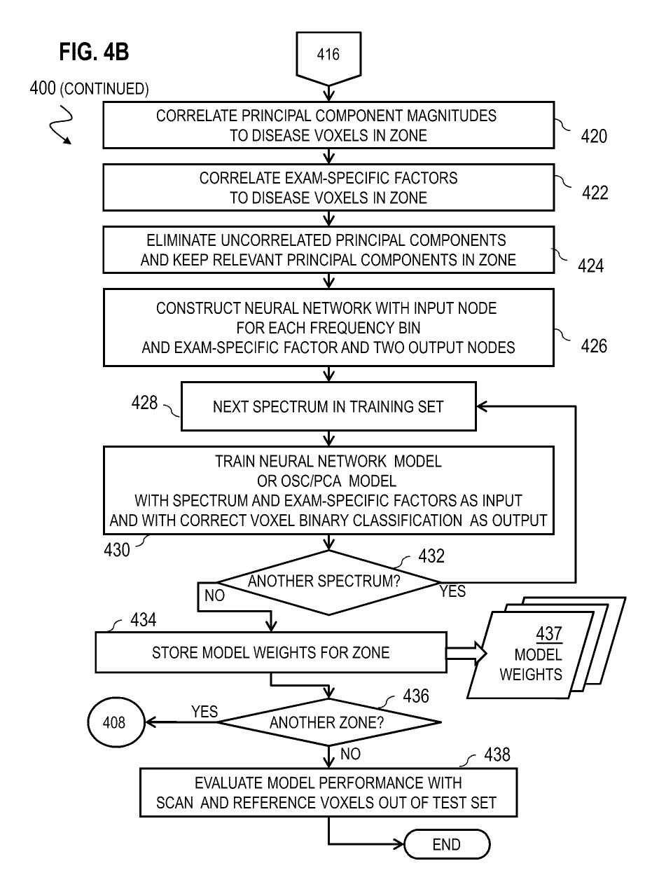

The segmentation module 316, segments the voxels from the high spatial resolution MRI images derived from the scan into one or more zones. Other data derivable from the imagery and used in OSC filtering, if any, are also determined in the module 316. The segmentation is based at least in part on definitions of the zones and OSC parameters of interest as determined by an expert. In some embodiments, manual input for segmentation is included in segmentation module 316. In some embodiments, this information is derived beforehand, as described in more detail below with reference to FIG. 4A and FIG. 4B, and stored in data structure 317. In some embodiments, data structure 317 includes a human anatomy database which has been generated by a specialized genitourinary radiologist as well as the definition of factors specific to the current patient examination such as MRSI lesion volume and degree of metabolic abnormality, data quality, endorectal coil sensitivity profile, periurethral location and zonal location. The output of the segmentation module 316 is data indicating a mapping between MRSI voxels and zone membership, which is stored in data structure 318. The location of high spatial resolution voxels in the MRI scan are translated to locations of the lower spatial resolution voxels of the MRSI spectra. In the illustrated embodiments, the values of exam-specific factors evident in the imagery data are output and stored in the exam-specific factors data structure 328. In some embodiments, the segmentation module is completely automatic and requires no human input or interaction to produce the output stored in data structures 318 and 328. In such embodiments, all available human knowledge to perform the segmentation is included in the zone definitions and OSC data structure 317.

The zonal separation module 308 is configured to select the spectra for voxels in a current one of the one or more zones, based on the zone mapping in data structure 318. This allows the spectra to be analyzed with principal components and neural networks tailored to that particular zone. In some embodiments, all spectra to be analyzed are in one zone, and the other zones, if any, merely indicate voxels in which the data is not suitable for classifying suspicion of malignant tissue; and therefore not subject to either principal component analysis or neural network processing. In some embodiments, the zonal separation module 308 simply labels a voxel with membership in one or more zones.

In the illustrated embodiment, the zonal separation module 308 is further configured to determine one or more values for corresponding one or more exam-specific factors based on the spectra in one or more zones and to store those values in the exam-specific factors data structure 328.

The OSC module 321 is configured to perform orthogonal signal correction (OSC) filtering, which effectively removes information unrelated to the separation of classes. For example, in some embodiments, the OSC module is further configured to indicate which principal components do not need amplitudes determined in order to classify a voxel as suspicious or not or tumor positive or not. In some embodiments (not shown), the OSC module 321 is further configured to consider one or more values in the exam-specific factors data structure 328.

The principal components module 320 is configured to determine the amplitudes in a current spectrum of the principal components predefined and stored in data structure 322. The data structure 322 is depicted as layered to indicate different principal components for different zones. The principal components are derived beforehand based on a training set, as described in more detail below with reference to FIG. 4A and FIG. 4B, and stored in data structure 322. The amplitudes determined in module 323 are used as values for a functional form previously fit to expert classifications for training data. In some embodiments, the principal component module is further configured to determine amplitudes only for a relevant subset of principal components that are useful in classifying the voxel as suspicious (or otherwise tumor positive) or not, e.g. based on results from the OSC module 321.

The output of principal components module 323 is a set of voxels classified as suspicious (or otherwise tumor positive) for representing malignant tissue; and the output is provided on output port 330a.

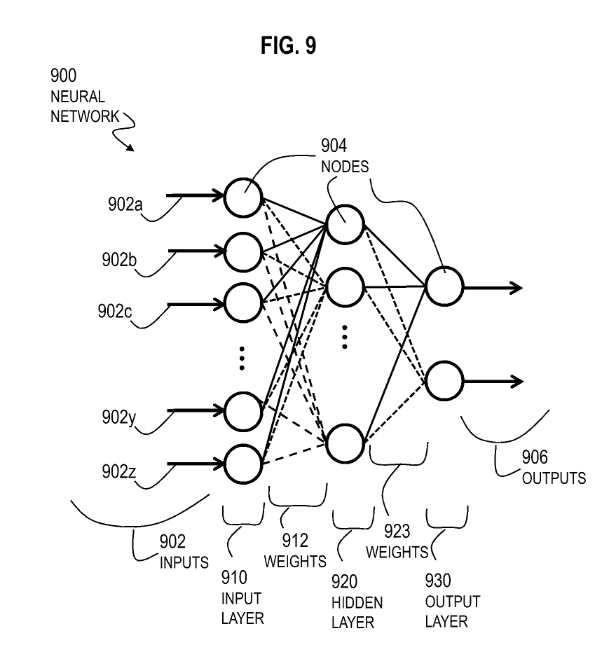

The neural network module 324 is configured to accept values for a predefined set of neural network input nodes based on amplitude values of a spectrum from module 308 for each voxel in the zone, and zero or more exam-specific factors from data structure 328, such as zone associated with the voxel. The neural network module 324 then classifies each voxel using predefined neural network weights among predefined layers of neural network nodes. The neural network nodes, layers and weights are derived beforehand, as described in more detail below with reference to FIG. 4A and FIG. 4B and FIG. 9, and stored in data structure 326. The data structure 326 is depicted as layered to indicate different weights or different numbers of node and or layers for different zones.

The output of neural network module 324 is a set of voxels classified as suspicious (or otherwise tumor positive) for representing malignant tissue; and the output is provided on output port 330b.

In some embodiments, either principal components module 323 or neural network module 324, and corresponding data structures 322 and 326, respectively, is omitted, and system 300 performs a single classification.

FIG. 4A and FIG. 4B constitute a flowchart that illustrates an example process 400 for deriving predefined data used by one or more modules of the system 300, according to one embodiment. Although steps in FIG. 4A and FIG. 4B are shown in a particular order for purposes of illustration, in other embodiments, one or more steps may be performed in a different order or overlapping in time, in series or in parallel, or one or more steps may be omitted or added, or changed in some combination of ways.

In step 402, a training set of NMR scans of prostates is received. Any method may be used to receive this data. For example, in various embodiments, the data is included as a default value in software instructions, is received as manual input from a network administrator on the local or a remote node, is retrieved from a local file or database, or is sent from a different node on a network, either in response to a query or unsolicited, or the data is received using some combination of these methods. In various embodiments, MRI and MRSI voxels from 10 or more of the 18 patients in the data base described above are used to produce the training set. In various embodiments, 70 percent of the thousands of MRSI voxels from a portion of the data base are used in a training set, 15 percent of the MRSI voxels are used in a validation set during formation of the models, and 15 percent of the MRSI voxels are used in a test set that is not used during formation of the models.

Step 402 includes any conditioning of images and spectra, e.g. by modules 304 or 314 or both. For example, in some embodiments, conditioning includes processing spectral data with commercially available software, well known in the art, such as free software 3DiCSI v1.9.11 (available in directory 3dicsi.html from public Internet domain mrs.cpmc.columbia in class edu). Using this software, the MRSI data were spatial zero filled to a 16×8×16 matrix and zero filled in the spectral dimension to 1024 points. The time-spectral dimension was apodized with a 4-Hz Gaussian function. The spectra were aligned and referenced to the water peak at 4.7 ppm or some other peak or not aligned at all in various embodiments. Magnitude spectra in a desired frequency shift range (e.g., 3.6 ppm to 0.6 ppm in some embodiments and 4.3 ppm to 0.4 ppm in some embodiments) were exported to achieve better and reproducible results in the subsequent modeling, as well as to fully automate and simplify preprocessing. In other example embodiments, spectral data were automatically processed by Functool software (GE Medical Systems). The data in GE format within the desired frequency shift range were used and magnitude spectra were exported for further analysis.

In step 404, reference data is received, in any manner as described above. The reference data indicates voxels of the training set associated with disease, e.g., a malignant tissue of the prostate gland. In some embodiments, the reference data is based on conclusions of an expert radiologist. In some embodiments, the reference data is based on post operative histology for the same tissues that had been imaged pre-operatively in the training set of scans. For example, all patients whose pre-operative scans are used to generate the training set subsequently undergo radical prostatectomy with whole-mount step section pathology. This “gold standard” information is made available to form or improve the system 300. Information on tumor location and size from the pathology analysis is incorporated into the training set to improve its discriminatory power. A very large training data set is available at Memorial Sloan Kettering Cancer Center (MSKCC) because of the large volume of patients who undergo endorectal MRI/MRSI of the prostate.

In step 406, the voxels in each scan of the training set are divided into zones of anatomical or analytical significance. In some embodiments, step 406 may be repeated several times until it is understood what are appropriate zones and OSC filtering values, based on results obtained during step 438, described below. In some embodiments, step 406 is performed, at least initially, based on a priori knowledge of reasonable zone definitions, e.g., based on the scientific literature. Human input and intervention is expected, especially initially, during step 406. The decisions on how to define zones for automated segmentation are captured as segmentation rules and parameters in zone definitions and OSC data structure 317. In an illustrated embodiment, the zone definitions include rules for segmenting anatomical portions of the prostate using any method known in the art. Identifiers for one or more of the OSC filtering properties, such as MRSI lesion volume and degree of metabolic abnormality, data quality, endorectal coil sensitivity profile, periurethral location and zonal location are also included in the data structure 317. All scans in the training set, as well as the voxels selected from the data base for the validation set or test set, are segmented during step 406.

For example, according to some embodiments, a zone excludes voxels that indicate a urethra within the prostate. According to some embodiments, the zone excludes voxels with certain artifacts, such as those recognized to include contamination by lipids. According to some embodiments, the zone excludes voxels with low data quality, such as low signal to noise ratio.

The steps 408 through 436, described below, are repeated for each zone for which voxels are to be classified. In some embodiments, voxels in one or more zones, e.g., a zone outside the prostate gland, are not to be classified.

In step 408, the frequency axes of all the NMR spectra in one zone are aligned. This alignment is described in more detail below. In some embodiments, alignment is based on the location of the suppressed water peak. In other embodiments, the suppressed water peak is considered too variable because of the suppression techniques, and the axes are aligned using some other peak, such as the CIT peak, or other feature of the spectra.

In step 410, non-diagnostic spectra are eliminated. For example, spectra with artifacts or low signal to noise ratio (SNR) are eliminated. In some embodiments, the non-diagnostic spectra are already eliminated by virtue of the zone segmentation, and step 410 is omitted

In step 412, values for the exam-specific factors are determined for the current scan.

In step 414, it is determined whether there is another scan of the training set with voxels in the current zone. If so, control passes back to step 408 to align the frequency axes of the spectra in the current zone and the next scan. If not then control passes to step 416.

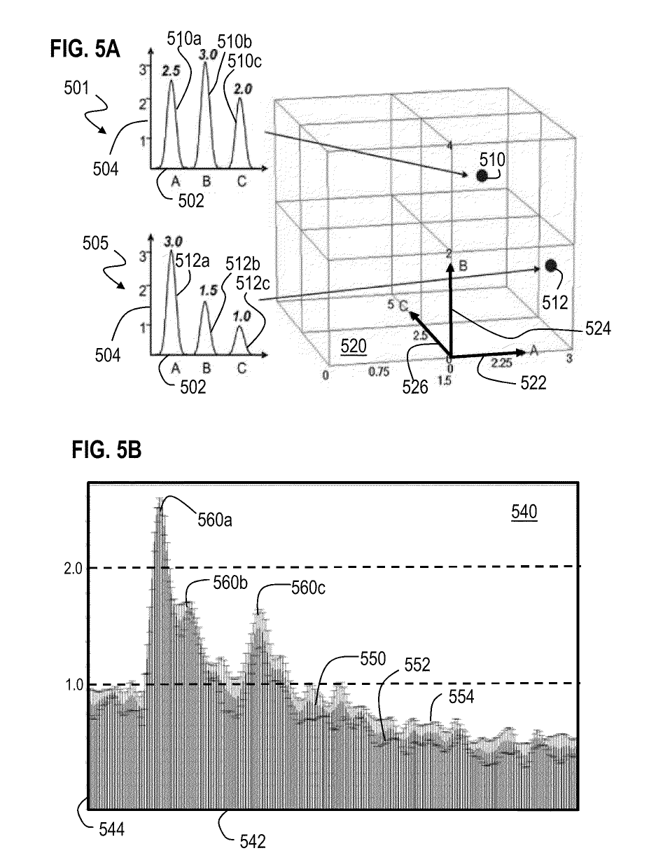

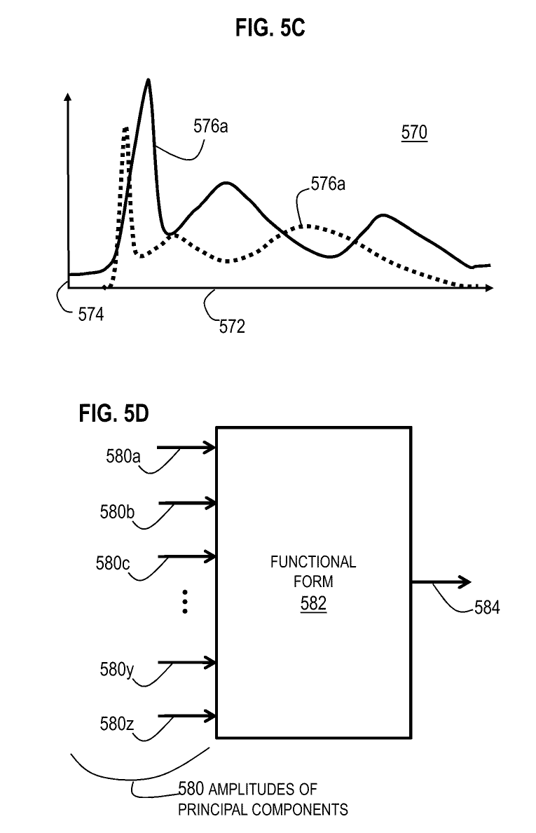

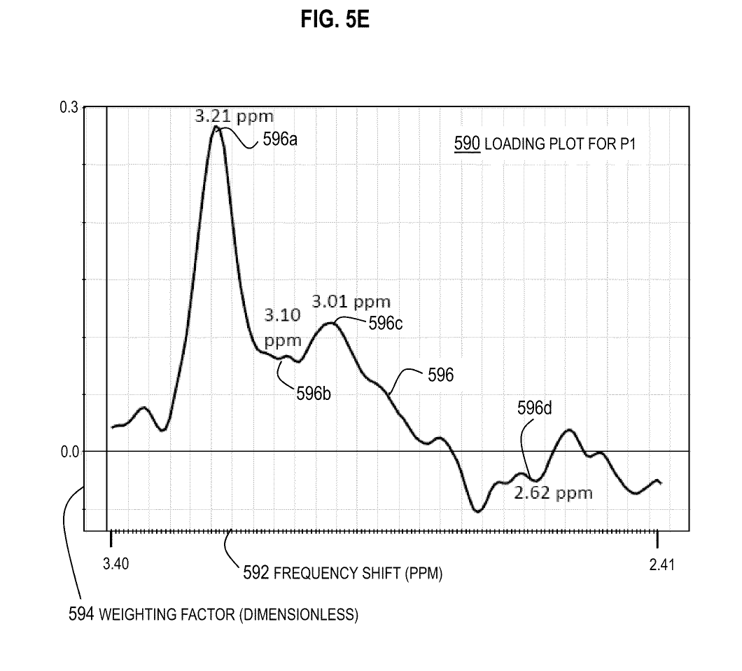

In step 416, the principal components are determined for all diagnostic spectra in all scans in the current zone. The determination of principal components of arbitrary data series is well known in the art, and any known method may be used. As a result, the definitions of principal components are stored in data structure 322. In some embodiments the principal components are Gaussian peaks centered on the known resonances for choline (CHO), creatine/phosphocreatine (CR), polyamines (PA) and citrate (CIT) among others. FIG. 5A is a diagram that illustrates example principal components and corresponding amplitudes, according to an embodiment. These simple principal components are peaks centered on frequencies A, B and C (e.g., at 2.21 ppm, 2.62 ppm and 2.06 ppm). Graph 501 shows a spectrum with a peak 510a at frequency A with an amplitude of 2.5, a peak 510b at frequency B with an amplitude of 3.0 and a peak 510c at frequency C with an amplitude of 2.0. This spectrum maps to a 3-D principal component multivariate space 520 at point 510. Similarly, graph 505 shows a different spectrum with a peak 512a at frequency A with an amplitude of 3.0, a peak 512b at frequency B with an amplitude of 1.5 and a peak 512c at frequency C with an amplitude of 1.0. This spectrum maps to 3-D multivariate space 520 at point 512. All spectra map to a collection of points in principal component space, of which some points are classified as tumor positive.

The data structure 322 is depicted as layered to indicate different principal components for different zones. Typically, the definition includes for each principal component, also known as an eigenfunction, a relative value at each frequency value. The principal components have the property that they are orthogonal to each other. Each principal component has associated a value, also known as an eigenvalue, that is proportional to the percent of the total variance accounted for by magnitude changes of that principal component. Thus the principal components can be ranked by eigenvalues, importance increasing with eigenvalue. In some embodiments, the ranks, or eigenvalues, are included in the data structure 322. FIG. 5B is a graph 540 that illustrates importance of frequencies in an MSRI spectrum for classifying a voxel as tumor positive or not, according to an embodiment. The horizontal axis is frequency shift in parts per million (ppm) for the range from 3.6075 ppm on the left to about 0.58 on the right. The vertical axis is relative importance without dimensions. Graph 540 is called a variable importance plot (VIP) and depicts the importance of inputs (frequency shift) in a model differentiating tumor spectra from other spectra. Frequency shifts with VIP values greater than 1 are the most relevant for explaining differences between classes or clusters of spectra. The mean values of VIP are shown in trace 550 with plus one standard deviations shown as trace 554 and minus one standard deviation as trace 552. Peaks 560a, 560b and 560c, associated with CHO, CR and CIT, respectively, are most important in distinguishing classes of spectra associated with tumors.

The principal components need not be simple peaks, but can be more complicated. In some embodiments, the principal components are determined using empirical orthogonal functions of arbitrary shape determined by the training set itself. FIG. 5C is a graph 570 that illustrates example empirical orthogonal functions 576a and 576b used as principal components, according to another embodiment. The horizontal axis is frequency shift, and the vertical axis is relative intensity. Empirical orthogonal functions are defined to have a total variance of 1. The amplitude is the factor by which an empirical orthogonal function is multiplied to fit a particular spectrum. Typically most of the variance in a set of spectra can be fit by a very small number of empirical orthogonal functions.

In step 420, depicted in FIG. 4B, the magnitudes of the principal components for the voxels in the zone are correlated to the tumor classification of the voxel in the reference data. This is because the principal components with the greatest eigenvalue or rank, might not be relevant to classifying voxels as suspicious of disease. Similarly, in step 422 the values of the exam-specific factors for each scan, if any, are correlated to the number or locations of disease suspicious (or otherwise tumor positive) voxels in the reference data for the scan.

In step 424, the uncorrelated principal components are eliminated from a set for which amplitudes are to be included as input to the model, such as a polynomial or other functional fit or the neural network, for the current zone. The other principal components are considered the relevant principal components for which amplitudes are to be included as input to a functional form or a neural network for the current zone.

Partial least squares (PLS) are used to convert principal component amplitudes to a classification output using a functional form. For example, in some embodiments, multivariate analysis was performed using SIMCA-P software v.11.5 from Umetrics of Sweden. FIG. 5D is a block diagram that illustrates example use of a functional form to classify a voxel based on amplitudes of principal components, according to an embodiment. The amplitudes 580 of the relevant principal components serve as inputs to the functional form 582 and one or two classification values are output 584. For example, in some embodiments, the amplitudes 580a, 580b, 580c, 580y, 580z and others indicated by ellipsis of corresponding principal components, such as six or more peaks in the VIP graph, are input to the function form.

In various embodiments, three different approaches to variable centering and auto scaling were compared (centered and scaled to Unit Variance (UV); centered but not scaled (Ctr); no centering or scaling (None)). The OSC algorithm was used to remove unwanted variation in the spectra that was irrelevant for the classification. Five orthogonal components were removed that removed over 70% of variation that did not contribute to discrimination.

In an example embodiment, using 10 patients and 2740 voxels, the principal components were determined to be the frequency shift bins between 3.4 ppm and 2.41 ppm. The overall predictive power (Q2) calculated by cross-validation was greater than 80.4% (a success rate dominated by the large number of healthy, tumor negative voxels). Cross-validation was performed by dividing the data set (for the ten patients) into seven parts, and for each run one seventh were left out as a test set and the other six sevenths constituted a training set used to generate the model. The model is used to classify the voxels in the test set. The process is repeated six more time, using a different one seventh as a test set. The model classifications are compared to the expert classifications; and the sum of the squared errors (called the Predicted Residual Sum of Squares, PRESS) calculated for the whole data set. The PRESS values is divided by an initial sum of squares and subtracted from 1 to give the value Q2. The lower the PRESS value, and thus the higher the Q2 value, the better the model is.

The functional form for the tumor positive output (P1) is represented by the loading plot, which depicts the weights for each frequency in the frequency range. FIG. 5E is a graph 590 that illustrates example functional form 596 for classifying voxels, according to an embodiment. The horizontal axis 592 is frequency shift in ppm; and the vertical axis 594 is weighting factor (dimensionless). The loading plot 590 describes the correlation that the principal component has with the original variable, e.g., the voxel classification. This is done by measuring the angle the component makes with the original variable axis and taking its cosine. A high value (max=1) means that the component is aligned with the original variable, a value close to zero value shows that it has no influence. A low value (min −1) indicates an opposite influence (negative correlation). The classification output value P1 is computed by multiplying the amplitudes of each frequency shift by the corresponding value of the function 596 and summing all weighted amplitudes.

In step 426, a neural network is constructed with an input layer that includes a node (also called a neuron in this art) for an amplitude for each frequency bin in a spectrum for one voxel, and an input node for a value of each exam-specific factor, if any, found correlated to disease classified voxels in a scan. The output layer includes two nodes, one for degree of suspicion that the voxel represents diseased tissue, e.g., malignant prostate tissue, and a second node for degree to which the voxel appears to represent tissue that is clear of the disease. The model also contains one or more hidden layers, each with an intermediate number of nodes. For example, in one embodiment described below, a neural network is constructed with 133 input layer nodes, 45 nodes in one hidden layer and two output layer nodes. As is well known in the art, the values in one layer of a neural network are based on the values in the previous layer and a set of weights connecting each node in one layer to each node in the previous layer. The weighted sum of the inputs is typically multiplied by a sigmoid function that levels off at large negative values and large positive values for the sum. In a preferred embodiment, there is one input node for each of the 256 frequency shifts in the range from 4.3 ppm to 0.4 ppm, six nodes in a hidden layer, and two nodes in the output layer. In other embodiments, other neural network structures in terms of number of layers and number of nodes per layer, are employed.

FIG. 9 is a diagram 900 that illustrates an example artificial neural network (ANN), according to an embodiment. The artificial neural network 900 comprises an input layer 910, a hidden layer 920 and an output layer 930. Each layer comprises one or more nodes 904, such as memory locations that store data values, as described in more detail below. The input nodes receives input data 902, such as intensity of each of one or more frequency shifts in a voxel spectrum (e.g., inputs 902a, 902b, 902c and others indicated by ellipsis) and any scan specific information, if any, such as prostate anatomical zone (e.g., inputs 902y and 902z). The output nodes 930 provide output data 906 that indicates the degree or probability of classification as tumor positive or tumor negative. In between are one or more hidden layers that contain nodes that hold values based on a weighted sum of values from the nodes of the previous layer, such as the input layer.

There is a weight associated with each connection between every node in the input layer and each node in the hidden layer, as indicted by the weights 912 in FIG. 9. The weights 912 for all the input layer nodes at the first hidden layer node are illustrated with solid line connections. The weights 912 for all the input layer nodes at the second hidden layer node are illustrated with dotted line connections. The weights 912 for all the input layer nodes at the last hidden layer node are illustrated with dashed line connections. Similarly, there is a weight associated with each connection between every node in the hidden layer and each node in the output layer, as indicted by the weights 923 in FIG. 9. The weights 923 for all the hidden layer nodes at the first output layer node are illustrated with solid line connections. The weights 923 for all the hidden layer nodes at the second output layer node are illustrated with dotted line connections.

The neural network model is not complete until the weights are determined for all connections between nodes in adjacent layers. The weights are determined based on the training set for which the output layer values are known, e.g., (1,0) for voxels marked suspicious (or otherwise tumor positive) in the reference data and (0,1) for voxels marked non-suspicious (or otherwise tumor negative) in the reference data. This process of setting the weights is called training the neural network, and several methods for training are well known in the art, including back propagation. In some embodiments, multilayer perceptron networks (MLP) were implemented using MATLAB's Neural Network Toolbox (Mathworks; Natick, Mass.), including both determining the weights for the connected nodes of the neural network and operating the neural network thus formed. In some embodiments, the ANN was implemented using Statistica Neural Networks from Statsoft of Tulsa, Okla.

In step 428, the spectrum for the next voxel in the training set for the current zone is selected. In step 430, the model to be used (e.g., either the neural network or the functional form for principal component amplitudes, or both) is incrementally trained based on the known inputs and the desired output for that voxel. The desired output is the classification provided in the reference data for this voxel, either a label by the spectroscopist or based on the histology by the pathologist. The known inputs are the amplitudes of the relevant principal components and the values of the exam-specific factors, if any, retained as input for the least squares fit of a functional form. The known inputs are the amplitudes of the spectral frequency bins and the values of the exam-specific factors, if any, retained as input for the neural network. Note that the exam-specific values are constant for all voxels in one scan in the current zone, but may change as voxels are selected from a different scan or zone. The training is incremented based on this voxel, but the model is not completely trained until all training set voxels in the zone are processed. In step 432, it is determined whether there is another spectrum, i.e., whether there is another MRSI voxel in the zone for any of the scans of the training set. If so, control passes back to step 428 and 430 to continue training the model. If not, then the training is finished, and control passes to step 434.

In step 434 the model weights for the zone are stored in data structure 437. The data structure 437 is depicted as layered to indicate different weights for different zones and different models. For principal components, the functional form and coefficients for the zone are stored in principal components data structure 322 represented by data structure 437. For neural networks, the network structure (layers and nodes) and weights for the zone are stored in neural network weights data structure 326 represented by data structure 437.

In step 436, it is determined whether there is another zone for which principal components or neural network weight, or both, are to be determined. If so, control passes back to step 408. Otherwise the classification model is complete.

If the model is complete, then in step 438 the model performance is evaluated with one or more scans that have reference data with correct classification but which have been excluded from the training set used to develop the model. Step 438 includes statistical analysis, as described below, in some embodiments. In some embodiments, a change to the model or data or definitions of zones, alone or in some combination is determined during step 438; and at least a portion of process 400 is repeated. For example, steps 406 and following steps are repeated if zone definitions are changed; while steps 426 and following are repeated if it is determined to change the number of nodes or layers in the neural network.

Thus using the steps in method 400, a system 300 is developed to classify voxels of MSRI data. Reasonably successful classification is obtained using a single zone, as described below, as well as with four prostate anatomical zones (O, U, PZ and TZ).

### Principal Component Models.

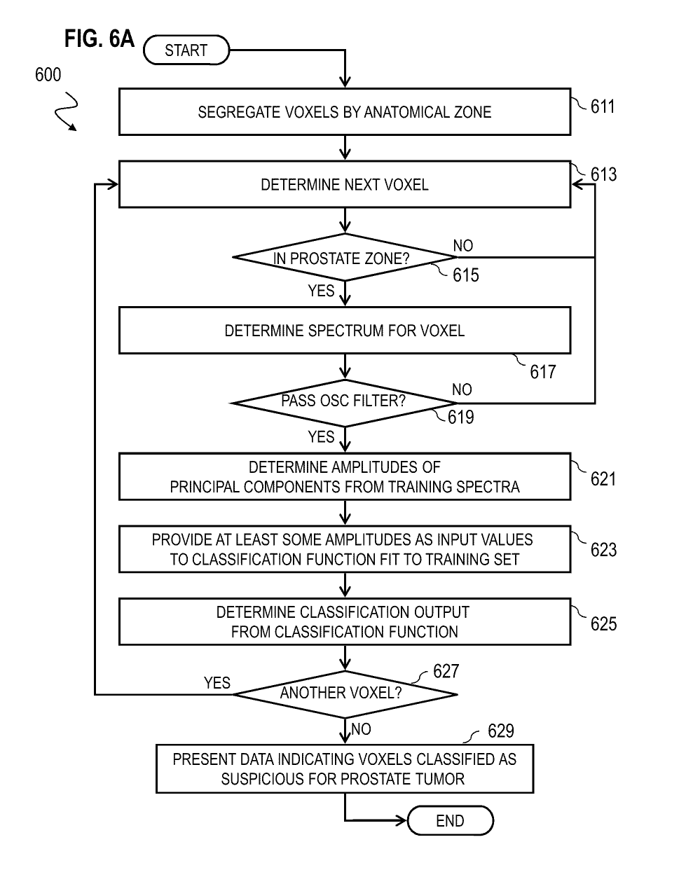

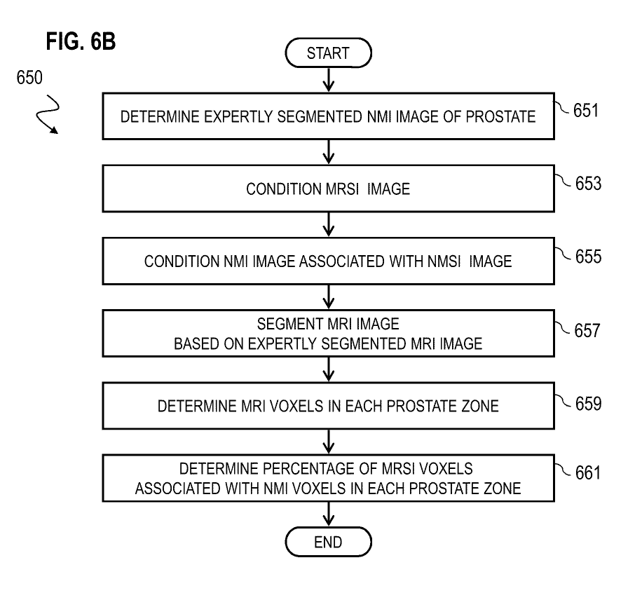

Some embodiments employ principal component models, alone or in combination with an artificial neural network. FIG. 6A is a flowchart that illustrates an example process 600 for classifying MRSI voxels using principal components, according to an embodiment.

In step 611, MRSI voxels are segregated by prostate anatomical zone. In some embodiments, voxels are determined to be inside the prostate or outside the prostate, i.e., in one of two zones, e.g., by comparison to manually input boundaries or automatically determined boundaries based on high resolution MRI images. In some embodiments, voxels are determined to be in one of multiple zones inside the prostate or outside the prostate, e.g., by comparison to manually input boundaries (as depicted in FIG. 2A) or automatically determined boundaries based on high resolution MRI images. In some embodiments the voxels are segregated simply by labeling them. In some embodiments, all voxels labeled for a current zone of multiple zones inside the prostate are processed further, while those labeled for different zones are skipped in step 611.

In some embodiments, step 611 comprises multiple steps. FIG. 6B is a flowchart that illustrates an example process 650 for segregating voxels by anatomical zone, according to an embodiment. Process 650 is a particular embodiment of step 611. In step 651, an expertly segmented image of a prostate is determined, e.g., by receiving boundary data manually input by a human expert. In some embodiments, step 651 is a library of segmented images for the prostates of other subjects different from the current patient that is the subject of the current MRI image and corresponding MRSI data. In some embodiments, data from this step is stored in the zone definitions data structure 317.

In step 653 the MRSI image data is conditioned, e.g. to determine the voxel locations relative to a MRI image, including aligning or calibrating data from one or more coils in the MRI device. Any image conditioning algorithm may be used. In step 655, MRI image data is conditioned, including aligning or calibrating data from one or more coils in the MRI device.

In step 657 the conditioned MRI image data is segmented based on the expertly segmented MRI images. For example, in some embodiments, the segment boundaries from one or more historical scans are warped to fit the current scan. In some embodiments, spectral classes from historical data are used to determine voxels inside prostate from voxels outside prostate based on data in the zone definitions data structure.

In step 659 the high resolution MRI voxels that are in each prostate anatomical zone are determined, e.g., by comparison of voxel locations to one or more boundary locations. In step 661, the low resolution MRSI voxels are associated with the MRI voxels in each prostate anatomical zone. For example, it is determined in step 551 that MRSI voxel 10 in FIG. 2A is 80% in the PZ 208 and 20% in the TZ 206. In some embodiments, voxel 10 is considered therefore to be a PZ voxel.

Returning to FIG. 6A, in step 613, the next voxel to be classified is selected from the voxels to be processed. For example, voxel 1 from FIG. 2A is determined to be the next voxel and is selected as the current voxel. In step 615 it is determined whether the current voxel is within one of the prostate anatomical zones. If not, control returns to step 613 to determine the next voxel. In some embodiments, only voxels from one of multiple zones inside the prostate are processed at one time, and voxels in other zones inside the prostate are skipped for processing at a different time.

In step 617 the spectrum for the voxel is determined. Step 617 includes any conditioning of the spectra desired for comparison to other spectra, such as padding, windowing, re-coloring, calibrating and other conditioning described above with reference to step 402 and modules 304 and 314.

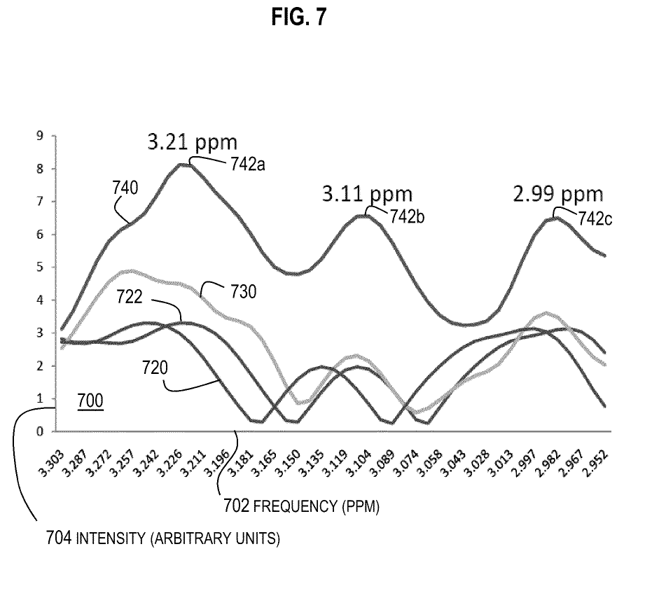

Step 617 also includes spectral alignment. In some embodiments the spectra are aligned to a water peak. In some embodiments, the spectra are not aligned or are aligned to a different peak because the water peak is suppressed, which can lead to migration of the maximum value off the true water resonance. Also alignment is rendered less effective in magnitude spectra because of increased peak widths, so, in some embodiments, spectral alignment is omitted. FIG. 7 is a graph 700 that illustrates alignment of peaks in multiple MRSI spectra, according to an embodiment. In the illustrated embodiment, the suppressed water peak is not used, or is not adequate, to align spectra. The horizontal axis 702 is frequency shift in ppm for the limited range from 3.3 ppm to 2.952 ppm; and, the vertical axis 704 is intensity in arbitrary units. Three spectra are plotted, including spectrum 720, spectrum 730 and spectrum 740. Strong peaks 742a, 742b and 742c are observed in spectrum 740 at 3.21 ppm, 3.11 ppm and 2.99 ppm, respectively, associated with total choline (CHO), polyamines (PA) and creatine (CR) respectively. These peaks are not all so well defined in spectra 720 and spectrum 730. However a polyamines (PA) peak appears in all three and can be used to align spectrum 720 with the other two spectra. Spectrum 722 represents spectrum 720 with a polyamines (PA) peak aligned with the corresponding peaks in spectrum 730 and 740. In some embodiments, using msalign Matlab function the spectra were aligned to the following peaks: Choline (CHO) at 3.22 ppm, Creatine (CR) at 2.98 ppm and Citrate (CIT) at 2.62 ppm with relative weights to fit peak 90, 60, 20 (respectively). While peak alignment was used with principal components, ANN results showed better performance for spectra without peak alignment.

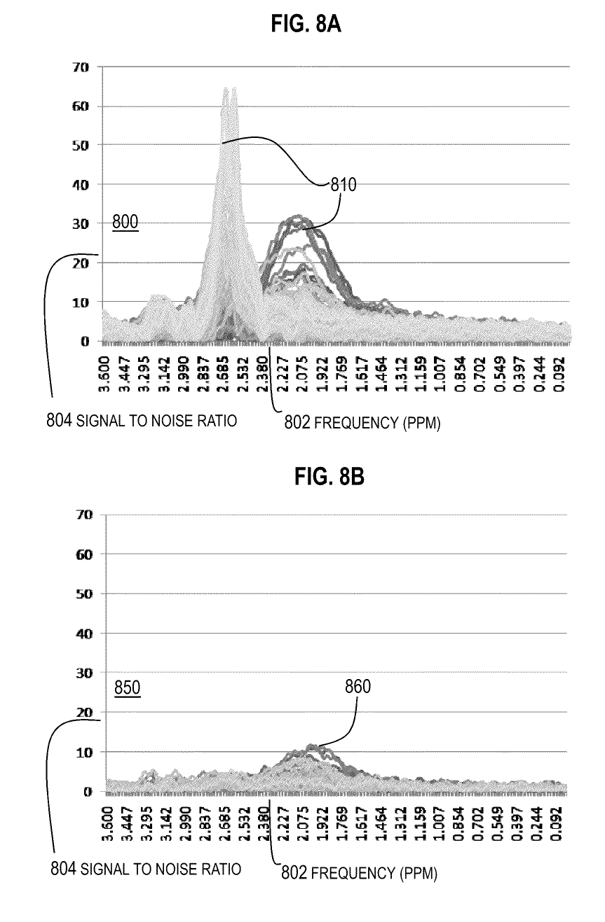

In step 619 it is determined whether the spectrum passes the OSC filter, e.g., OSC module 132, which effectively removes information unrelated to the separation of classes, such as principal components that do not need amplitudes determined, threshold values for one or more values in the exam-specific factors data structure 328, or voxels with spectra having signal to noise ratio below a threshold value, such as 10. FIG. 8A is a graph 800 that illustrates high signal to noise ratio (SNR) MRSI spectra, according to an embodiment. The horizontal axis is frequency shift in ppm for the range from 3.6 ppm to 0.092 ppm. The vertical axis 804 is signal to noise ratio (SNR), which is dimensionless. SNR is defined for this embodiment as the highest signal intensity in the range from 3.4 to 2.4 ppm divided by the standard deviation of the noise in the range from 1.3 to 0 ppm. In other embodiments, other definitions of SNR are used. Multiple spectra 810 are plotted that exceed the SNR of 10 in one or more sections of the frequency shift range. FIG. 8B is a graph 850 that illustrates low SNR MRSI spectra, according to an embodiment. The horizontal axis 802 and vertical axis 804 are as described above. Multiple spectra 860 are plotted that do not exceed the SNR of 10 in any sections of the frequency shift range. Such low SNR spectra were found not useful during classification of voxels with the principal component method.

If a voxel does not pass the OSC filter, then control passes back to step 613 to determine the next voxel to make the current voxel. If a voxel does pass the OSC filter, then, in step 621, the amplitudes in the current voxel are determined for the principal components of the training set of voxel spectra. For example, the amplitude of the most important peaks in the spectrum of the current voxel are determined in step 621.

In step 623, the amplitudes of at least the most important principal components are input to the functional form, e.g., inputs 580 are input to the functional form represented by block 582, such as loading plot 596. In some embodiments, the amplitudes are input to a neural network instead of a functional form during step 623.

In step 625, the classification for the voxel is determined based on the output from the functional form. For example, a voxel for which an output is near 1.0 is classified as tumor positive; while, a voxel for which an output is near 0.0 is classified as tumor negative.

In step 627, it is determined if there is another voxel in the set to be classified. If so, control passes back to step 613 to select the next voxel as the current voxel. Otherwise, in step 629, data is presented that indicates the voxels classified as suspicious of a tumor or otherwise tumor-positive. For example, an MRI image is presented with a MRSI voxel outline for each voxel classified as tumor positive, as in image 220 depicted in FIG. 2B.

In some embodiments, the classification accuracy for the model was computed as the ratio of the number of spectra predicted correctly to the total number of spectra in the test set. Such values were provided by the SIMCA-P software in the variable YPredPS. YPredPS is the Y value predicted by the model based upon the X block variables (resonance intensities at given ppm). A YPredPS value close to 1 indicates that the object is likely to belong to the class. (e.g., tumor positive) A YPredPS value close to 0 indicates that the object is unlikely to belong to the class (e.g., tumor positive)

In the computed models after OSC filtering, the first PLS component explained greater than 82.1% of the variation in the spectra between healthy and tumor voxels. The overall predictive power of the training set calculated by cross-validation was greater than 80.4%. Using the models generated by the training set, the spectra in the test set were correctly predicted greater than 81% of the time, dominated by the tumor-negative voxels. The results were dependent on the choice of training datasets and peak position variation. Frequency shifts with Variable Importance in the Projection (VIP) values larger than 1 are the most relevant for explaining differences between classes of spectra. The most important variable in differentiating tumor and healthy voxels was the CHO amplitude at 3.2 ppm. CR, PA and CIT amplitudes also had VIP values greater than one and thus were important for differentiating cancer voxels The best results for a test set of voxels and principal components were obtained by not applying scaled or centered spectra during least squares fitting of he classification values. The modeling results presented here show that the multivariate principal component amplitudes, as PLS method with OSC, works well with the tested data sets and could help to automatically distinguish the tumor-suspicious voxels. An important advantage of this method is the much shorter time of analysis compared to visual inspection and the possibility of broad implementation in cancer centers not employing experienced spectroscopists.

### Artificial Neural Network Models.

Some embodiments employ artificial neural network ANN models, alone or in combination with principal components. These embodiments show higher percentages of correct classification of tumor positive voxels in the MRSI data. For the artificial neural networks the prostate voxels data base was randomly divided, 70% in a training set, 15% in a validation set, and 15% in a test set.

In one embodiment of the ANN, the input layer 910 included 133 nodes 904 corresponding to all frequency shift bins from 3.4 ppm to 2.4 ppm—the same frequency range used for the principal components model. In this embodiment, the hidden layer 920 included 25 nodes. The two output layer 930 classification nodes were trained based on spectroscopist assessments, and correspond to suspicious for tumor (a type of tumor positive) and non-suspicious (a type of tumor-negative).

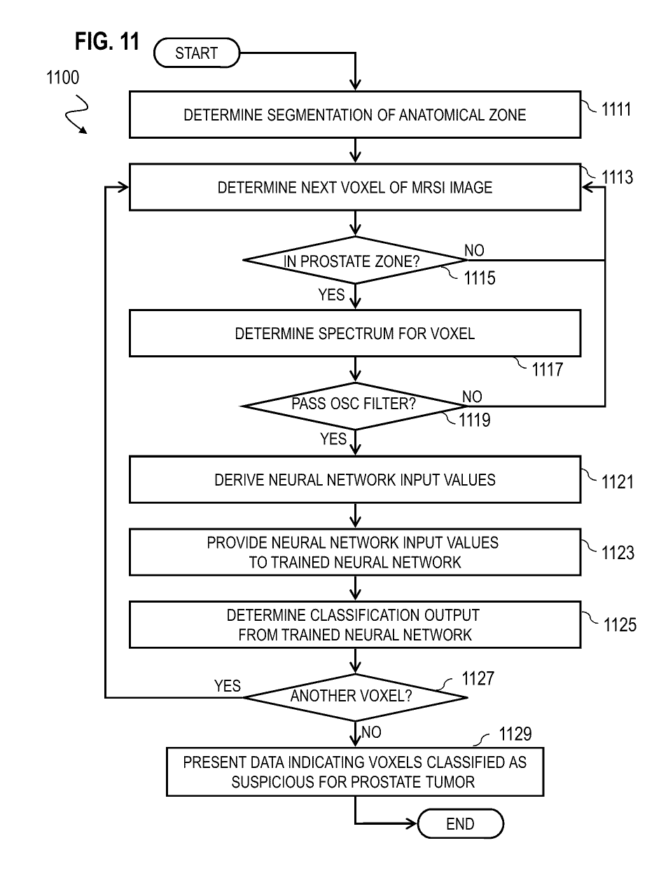

The ANN models are used as depicted in FIG. 11. FIG. 11 is a flowchart that illustrates an example process 1100 for classifying MRSI voxels using an artificial neural network, according to an embodiment. In step 1111, MRSI voxels are segregated by prostate anatomical zone, as described above for step 611. In some embodiments, step 1111 comprises multiple steps as shown in FIG. 6B. Process 650 is a particular embodiment of step 1111.

In step 1113, the next voxel to be classified is selected from the voxels to be processed. For example, voxel 1 from FIG. 2A is determined to be the next voxel and is selected as the current voxel. In step 1115 it is determined whether the current voxel is within one of the prostate anatomical zones. If not, control returns to step 1113 to determine the next voxel. In some embodiments, only voxels from one of multiple zones inside the prostate are processed at one time, and voxels in other zones inside the prostate are skipped for processing at a different time.

In step 1117 the spectrum for the voxel is determined. Step 1117 includes any conditioning of the spectra desired for comparison to other spectra, such as padding, windowing, re-coloring, calibrating and other conditioning described above with reference to step 402 and modules 304 and 314. In some embodiments, spectra are aligned as described above for step 617; however, in many example embodiments of ANNs, step 1111 excludes spectral alignment.

In step 1119 it is determined whether the spectrum passes the OSC filter, e.g., OSC module 132, which effectively removes information unrelated to the separation of classes, such as frequency shifts that do not need amplitudes determined, threshold values for one or more values in the exam-specific factors data structure 328, or voxels with spectra having signal to noise ratio below a threshold value, such as 10. If a voxel does not pass the OSC filter, then control passes back to step 1113 to determine the next voxel to make the current voxel. If a voxel does pass the OSC filter, then control passes to step 1121. In some embodiments, a SNR threshold is used as described above for step 619; however, in many example embodiments of ANNs, no OSC is performed and step 1119 is omitted.

In step 1121, the amplitudes of multiple spectral frequencies in the current voxel are determined as input to the ANN. In step 623, the amplitudes of at least the most important frequency shifts are input to the ANN, e.g., inputs 902 are input to the input layer 910 nodes 904. In step 1125, the classification for the voxel is determined based on the output from the ANN. For example, a voxel for which a first output layer 930 node holds data with a value near 1.0 and a second output node holds data with a value near 0.0 is classified as tumor positive. Similarly, a voxel for which the first output layer 930 node holds data with a value near 0.0 and the second output layer node holds data with a value near 1.0 is classified as tumor negative.

In step 1127, it is determined if there is another voxel in the set to be classified. If so, control passes back to step 1113 to select the next voxel as the current voxel. Otherwise, in step 1129, data is presented that indicates the voxels classified as suspicious of a tumor or otherwise tumor-positive. For example, an MRI image is presented with a MRSI voxel outline for each voxel classified as tumor positive, such as image 220 of FIG. 2B.

In one ANN embodiment, described above (called ANN1, hereinafter), the ANN was trained and resulting classifications evaluated based on the tumor suspicious voxels identified by the spectroscopist. ANN1 Includes 133 nodes in the input layer, 25 nodes in the hidden layer and two nodes in the output layer. The inputs to the input layer are 133 frequency shift amplitudes from the voxel spectra from 3.4 to 2.4 ppm. The results are presented in Table 1 by combining the classifications of the training set, the validation set and the test set. While a significant number of the ANN results were not consistent with the suspicious voxels, because of the small number of suspicious voxels, the overall agreement is quite high (over 97%).

TABLE 1
ANN1 classification summary:

| | Non-suspicious | | |
|---|---|---|---|
| | by | Suspicious by | |
| | spectroscopist | spectroscopist | Combined |
| Total # voxels in test | 2624 | 116 | 2740 |
| set | | | |
| # ANN consistent | 2602 (99.16%) | 74 (63.79%) | 2676 (97.66%) |
| (%) | | | |
| # ANN inconsistent | 22 (0.84%) | 42 (36.21%) | 64 (2.34%) |
| (%) | | | |

In another two embodiments, the data set includes voxels from ten patients (age range from 36 to 68 years, median age 54 years). The data set was randomly divided into a training set (70%), validation set (15%) and test set (15%). The data set includes 2903 voxels. In these ANN embodiments (called ANN2 and ANN3 hereinafter), the ANNs were trained and resulting classifications evaluated based on the tumor positive voxels identified by the pathologist. ANN2 Includes 256 nodes in the input layer, 8 nodes in the hidden layer and two nodes in the output layer. The inputs to the input layer are 256 frequency shift amplitudes from the voxel spectra from 4.3 ppm to 0.4 ppm. ANN3 Includes 260 nodes in the input layer, 15 nodes in the hidden layer and two nodes in the output layer. The input to the input layer are 256 frequency shift amplitudes from the voxel spectra from 4.3 ppm to 0.4 ppm, as in ANN2, plus four nodes representing the percentage of the four prostate anatomical zones (O, U, PZ, TZ) in the voxel.

After training and validating, the results on the test sets are presented in Table 2 and table 3 for ANN2 and ANN3, respectively, by combining the classifications of the training set, the validation set and the test set.

TABLE 2
ANN2 classification summary:

| | tumor | tumor | |
|---|---|---|---|
| | negative by | positive by | |
| | pathologist | pathologist | Combined |
| Total # voxels in test set | 2817 | 86 | 2903 |
| # ANN consistent (%) | 2808 (99.68%) | 66 (76.74%) | 2874 (99.00%) |
| # ANN inconsistent (%) | 9 (0.32%) | 20 (23.26%) | 29 (1.00%) |

TABLE 3
ANN3 classification summary:

| | tumor | tumor | |
|---|---|---|---|
| | negative by | positive by | |
| | pathologist | pathologist | Combined |
| Total # voxels in test set | 2817 | 86 | 2903 |
| # ANN consistent (%) | 2808 (99.68%) | 79 (91.86%) | 2887 (99.45%) |
| # ANN inconsistent (%) | 9 (0.32%) | 7 (8.14%) | 16 (0.55%) |

ANN2 showed an overall correct classification rate at 99%; and ANN3 showed a slightly higher overall correct classification rate at 99.45%. Of greater interest is the correctness of classification of tumor voxels for which ANN3 with the segmentation information showed a correct classification rate of 91.9%—much higher than the correct classification rate of 76.7% by ANN2 relying on spectra alone. Nine false positive voxels were identified by both ANN2 and ANN3.

Tables 2 and 3 demonstrate fewer missed tumor voxels by ANN models compared to visual analysis by an experienced spectroscopist. As expected, both ANN models perform better than the visual analysis, because only true positive voxels confirmed by histopathology were used to train ANN, while this information is not available to the spectroscopist. This suggests a protocol for use of such ANN models in which voxels identified by ANN as tumor, but labeled as healthy by a spectroscopist, should be localized on histopathological maps to check whether they were missed by the spectroscopist.

In other embodiments, a different number of nodes are used in the ANN. These embodiments of ANN are based on the complete data set of 18 patients. In the following example ANN embodiments, the data set includes 5308 voxels within the PRESS excitation volume, of which 149 voxels are marked suspicious by a physicist/spectroscopist. Pathologist classification based on histology sections reveal that 101 of these 149 voxels are true positives that actually include a lesion, while 48 voxels were false positives by the spectroscopist. These ANN are trained to classify voxels that correspond to lesions (true positives) as tumor positive, rather than voxels marked suspicious by the spectroscopist.

Six sets of additional ANN models were trained on the same data set and tested on the 5308 voxels in the training set. Three of these model sets include 256 nodes in the input layer 910, but use different numbers of nodes in the hidden layer 920, either 4 or 5 or 6. The 256 input values for the input nodes are the amplitudes of the 256 frequency shift bins from 4.3 ppm to 0.4 ppm. The model sets are designated Set256-4, Set256-5 and Set256-6, respectively. The remaining three sets of these models include 260 nodes in the input layer 910, and use the same three numbers of nodes in the hidden layer 920, either 4 or 5 or 6. The 260 input values for the input nodes are the amplitudes of the 256 frequency shift bins from 4.3 ppm to 0.4 ppm and the percentages of the voxel in the four prostate anatomical zones. The model sets are designated Set260-4, Set260-5 and Set260-6, respectively. Thus each set represents a different arrangement (architecture) of ANN nodes. For each set of models, six models were trained—each using a different randomly selected 70% of the voxels in the full data set.

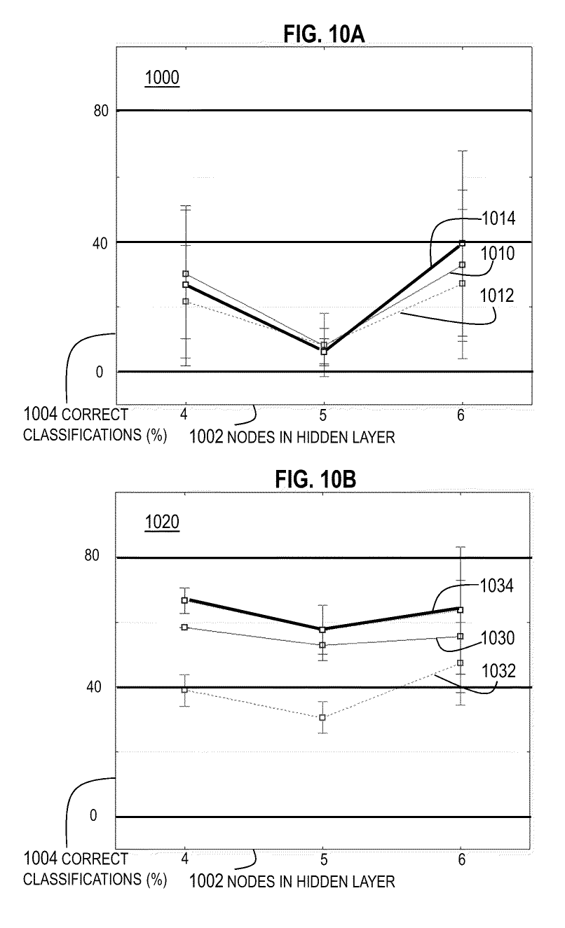

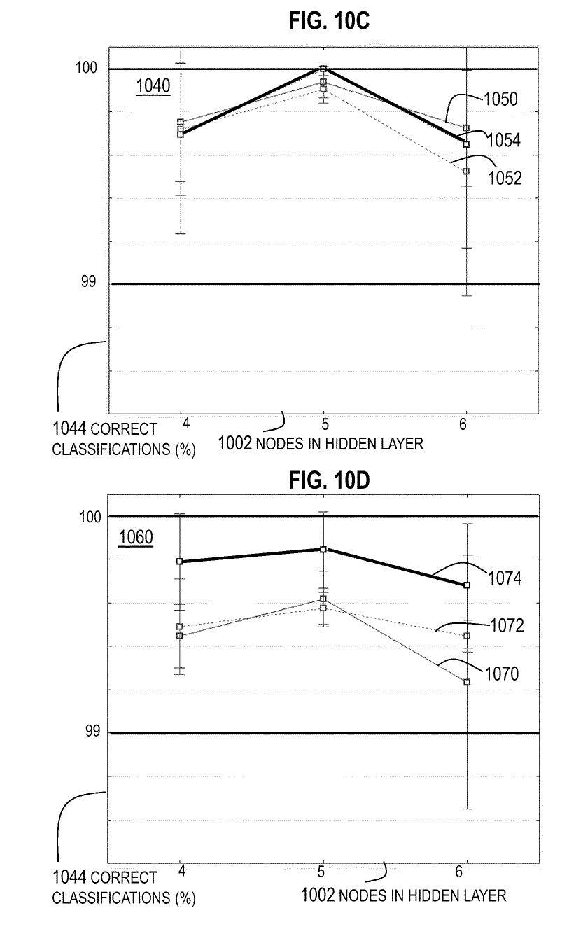

The classification summaries for these sets of ANN models are plotted in the graphs of FIG. 10A through FIG. 10D. FIG. 10A through FIG. 10D are graphs that illustrate example effects of nodes in a hidden layer of a neural network on successful classification of voxels, according to various embodiments. These plots also suggest the dependence of the ANN model on the precise training set used.

FIG. 10A is a graph 1000 that illustrates example percent correct classification for tumor voxels for Set256-4, Set256-5 and Set256-6. The horizontal axis 1002 indicates the ANN model set; and, the vertical axis 1004 indicates the percent of correct classifications. Plotted for each structure is the average percent correct classification of actual tumor voxels among all trained models in the set as an open square and plus and minus one standard deviation as vertical lines. In addition to the test set voxels, each ANN model in the set was run on the training voxels and the validation voxels. The mean correct classification percentages for the training set form trace 1010 across the three values for the number of nodes in the hidden layer. The mean correct classification percentages for the validation set form trace 1012 across the three values for the number of nodes in the hidden layer. The mean correct classification percentages for the test set form trace 1014 across the three values for the number of nodes in the hidden layer. Trace 1010 is expected to provide the best classification because those voxels were used to train the ANN models; however the correct classification rate is about the same for each, and is usually less than 40% correct. Using five nodes in the hidden layer appears to reduce the both the mean correct classification and the standard deviations about the mean values.

FIG. 10B is a graph 1020 that illustrates example percent correct classification for tumor voxels for Set260-4, Set260-5 and Set260-6 that include input indicating the prostate anatomical zone or zones for the input voxel. The horizontal axis 1002 indicates the ANN model set; and the vertical axis 1004 indicates the percent of correct classifications. The mean correct classification percentages for the training set form trace 1030 across the three values for the number of nodes in the hidden layer. The mean correct classification percentages for the validation set form trace 1032 across the three values for the number of nodes in the hidden layer. The mean correct classification percentages for the test set form trace 1034 across the three values for the number of nodes in the hidden layer. The correct classification rate for the training (trace 1030) and test voxels (trace 1034) is about 50%, which appears to be significantly better than for the validation voxels on trace 1032 and the sets with only 256 input frequency amplitudes in FIG. 10A.

FIG. 10C is a graph 1040 that illustrates example percent correct classification for healthy (tumor-negative) voxels for Set256-4, Set256-5 and Set256-6. The horizontal axis 1002 indicates the ANN model set; and, the vertical axis 1004 indicates the percent of correct classifications. The mean correct classification percentages for the training set form trace 1050 across the three values for the number of nodes in the hidden layer. The mean correct classification percentages for the validation set form trace 1052 across the three values for the number of nodes in the hidden layer. The mean correct classification percentages for the test set form trace 1054 across the three values for the number of nodes in the hidden layer. The correct classification rate is about the same for each, and is usually more than 99% correct. Using five nodes in the hidden layer appears to increase the mean correct classification and reduce the standard deviations about the mean values.

FIG. 10D is a graph 1060 that illustrates example percent correct classification for healthy (tumor-negative) voxels for Set260-4, Set260-5 and Set260-6 that include input indicating the prostate anatomical zone or zones for the input voxel. The horizontal axis 1002 indicates the ANN model set; and the vertical axis 1004 indicates the percent of correct classifications. The mean correct classification percentages for the training set form trace 1070 across the three values for the number of nodes in the hidden layer. The mean correct classification percentages for the validation set form trace 1072 across the three values for the number of nodes in the hidden layer. The mean correct classification percentages for the test set form trace 1074 across the three values for the number of nodes in the hidden layer. The correct classification rate is usually more than 99% correct. The correct classification rate for the test voxels (trace 1074) appears to be significantly better than for the training voxels on trace 1070 and the validation voxels on trace 1072. The correct classification rates appear to be somewhat lower than for the sets with only 256 input frequency amplitudes.

In a particular embodiment of the ANN model, the number of nodes in the hidden layer is 6 with 256 nodes in the input layer for input of spectra only, without anatomical zones, as in Set256-6. This particular embodiment performs better than the mean in FIG. 10A, however, and provides a 75% correct classification rate for tumor voxels in the test set. Not surprisingly, it also provides about 99% correct classification rate for healthy voxels.

The weights for this particular embodiment are given in Table 4a and Table 4b for the connections between each of the 256 input nodes to each of the six hidden nodes; and in Table 5 for the connections between each of the 6 hidden layer nodes to each of the two output nodes. Table 6. Indicates the bias, a factor added to the weighted sums for each hidden layer node and output layer node, as is well known in the art.

TABLE 4a
Weights for connections from input nodes to first 3 hidden layer nodes

| Input node resonance | | | |
|---|---|---|---|
| frequency | Hidden node 1 | Hidden node 2 | Hidden node 3 |
| −4.300000 | 0.9759750765426 | −1.2476243011454 | 0.5807940188322 |
| −4.284666 | 1.1513956876603 | −7.9919202155804 | 6.9701385089949 |
| −4.269333 | 1.2856711646887 | 8.3557889811644 | 8.9289369205622 |
| −4.254000 | 1.1790614452974 | 8.8882674742089 | 8.5828376684191 |
| −4.238667 | 8.4245314560316 | 2.5921848907895 | 6.4220018262245 |
| −4.223333 | 5.0258422048334 | −1.1022421688222 | 5.1487888689042 |
| −4.208000 | 2.9029261344328 | −1.6745285618902 | 4.4608372460699 |
| −4.192667 | 3.1198577535218 | −5.9395616348365 | 3.9101973280470 |
| −4.177333 | 3.9416713068975 | 5.3998701640098 | 3.4770822879470 |
| −4.162000 | 4.2967814888905 | 9.1484834634851 | 2.0756211191797 |
| −4.146667 | 4.4322990144643 | 1.0893510649496 | 7.3664355820559 |
| −4.131333 | 3.6458714453148 | 8.1858535158337 | 8.0522086455947 |
| −4.116000 | 3.2295030784832 | 3.4722910629533 | 1.9278015114915 |
| −4.100667 | 4.2013870519872 | 5.1747298634871 | 3.8074671930795 |
| −4.085333 | 5.5289495954561 | 6.6641427888934 | 5.4230130630513 |
| −4.070000 | 5.0512317688924 | −5.1838201873685 | 5.6210871902434 |
| −4.054667 | 4.1871383085323 | −2.0571791798253 | 5.7133946828314 |
| −4.039333 | 4.3775146542608 | −1.8266952565273 | 7.1743250873232 |
| −4.024000 | 5.9240963486077 | −6.7578321796816 | 8.0311212179541 |
| −4.008667 | 9.1855978307610 | 9.2334046614182 | 8.3443780389290 |
| −3.993333 | 1.2114393515333 | 1.8072844022546 | 7.5194992728221 |
| −3.978000 | 1.1128518853610 | −1.6602977924430 | 5.6273377527568 |
| −3.962667 | 9.6988741220930 | −5.7997048694299 | 2.3317627317593 |
| −3.947333 | 1.0755470470331 | −4.2892949025862 | −1.2692595375564 |
| −3.932000 | 1.1189276476327 | −9.2135890931652 | −5.6833737014873 |
| −3.916667 | 9.4338722848540 | 2.7952261080348 | −1.1590526086333 |
| −3.901333 | 5.4174627203336 | −4.2618451418948 | −1.3002087197289 |
| −3.886000 | 3.9670164268572 | −1.0362021904935 | −1.2914009068516 |
| −3.870667 | 4.5804098923237 | 1.3242918627371 | −8.7207232887039 |
| −3.855333 | 4.4531731033255 | 8.4715064113451 | −5.6880804049266 |
| −3.840000 | 6.2724608917489 | 1.5988016928376 | −1.0695103871427 |
| −3.824667 | 1.1711772952261 | 4.2887344782548 | 5.8922668530617 |
| −3.809333 | 1.6851751848429 | 5.4947697567331 | 1.1090656950842 |
| −3.794000 | 1.6188223341598 | 2.1389470502132 | 1.1303168820505 |
| −3.778667 | 1.1102782818206 | −1.7277366899159 | 7.8862968353902 |
| −3.763333 | 5.2167977169645 | −1.5969746996503 | 3.8522369295734 |
| −3.748000 | 1.1301910241504 | −3.6883557024156 | −5.6851513751717 |
| −3.732667 | −1.2773779579881 | −8.0964879403873 | −5.4664634929272 |
| −3.717333 | −1.1329260922630 | −1.4093495600025 | −8.4963480307519 |
| −3.702000 | −3.0914322673641 | −2.1236467792575 | −6.9964953350387 |
| −3.686667 | −4.4027703207441 | −3.1091271168789 | −2.2350635895313 |
| −3.671333 | −8.6249197056969 | −3.5499735161153 | −5.3448027937682 |
| −3.656000 | −6.6017248530103 | −9.2580709979418 | 1.6626320589866 |
| −3.640667 | −2.4718929394845 | 1.7783478477973 | 5.6589607828970 |
| −3.625333 | 2.6143071513167 | 2.5065917583987 | 7.5537667087403 |
| −3.610000 | −5.6349056140324 | 1.6561903738035 | 4.9356636459953 |
| −3.594667 | −1.1126056987881 | 1.0223347233192 | 4.0053444439164 |
| −3.579333 | −6.5630640774446 | 3.0372066660693 | 8.2517141275532 |
| −3.564000 | 2.3300918246135 | 5.1577065340714 | 1.1931647171918 |
| −3.548667 | 7.8663280596248 | 2.2910643954648 | 1.2051028856226 |
| −3.533333 | 1.0661060575785 | 2.0718789768050 | 1.0018093593966 |
| −3.518000 | 6.3227247055000 | −3.4410410244613 | 7.3494268476409 |
| −3.502667 | 7.1572666099970 | −2.0764392679055 | 3.0604245671263 |
| −3.487333 | 3.0670245845800 | −2.3405589154576 | 3.3024216034322 |
| −3.472000 | 6.6862155284755 | 2.2694372447412 | 4.2720007044444 |
| −3.456667 | 3.2799218064647 | 2.1090117131412 | 6.6969515697287 |
| −3.441333 | −3.1354640553266 | 6.7804383842990 | −2.5669095812901 |
| −3.426000 | −5.7095651434913 | −2.5535831662742 | −3.7637521134262 |
| −3.410667 | −4.2788145848469 | −3.5195005691385 | −4.0584146251518 |
| −3.395333 | −3.2496609551013 | 4.8603762878582 | −2.7641887348931 |
| −3.380000 | −2.8934248973387 | 1.1972067337384 | −9.8944235972683 |
| −3.364667 | −2.2080997116954 | 2.8042208373196 | −2.4703489461680 |
| −3.349333 | −1.3911385658883 | −9.8646956469316 | −6.2760600284448 |
| −3.334000 | −3.6993542158532 | −4.7183388725329 | −1.0286015951068 |
| −3.318667 | −7.6460879487752 | 5.4690842645863 | −1.1979187197005 |
| −3.303333 | −1.2506813822829 | 5.1174759036563 | −1.3580941687775 |
| −3.288000 | −2.0674256272478 | −1.7371423983197 | −1.8655508295469 |
| −3.272667 | −2.8870086981466 | −1.6005800158279 | −2.5049451995456 |
| −3.257333 | −3.3836834968662 | −2.8934190495312 | −2.6374935259473 |
| −3.242000 | −4.0934205537592 | −4.0003923680199 | −2.6795433064449 |
| −3.226667 | −3.7014323545980 | −4.4128446920583 | −2.1440341602667 |
| −3.211333 | −3.3329094848659 | −4.6836291407119 | −1.6697820478344 |
| −3.196000 | −2.8717747206341 | −4.0139959763705 | −1.0533012497379 |
| −3.180667 | −2.4037963847730 | −2.6800573452615 | −5.4156399117147 |
| −3.165333 | −1.7145425076534 | −4.8723006390753 | −1.4033912482298 |
| −3.150000 | −1.0625463883733 | 1.2371169593010 | 9.8379946606643 |
| −3.134667 | −6.1446236751653 | 1.4085043453116 | −3.6601788878401 |
| −3.119333 | −2.5675971480408 | 9.1786269679272 | −1.4375822380999 |
| −3.104000 | −1.1070205803802 | 5.6176671002442 | −2.3273402175054 |
| −3.088667 | −2.8539332675164 | 3.0070009406905 | −4.1659533892595 |
| −3.073333 | −4.7838231781989 | 2.5614383054845 | −5.5448582850182 |
| −3.058000 | −5.9953624250997 | 2.3290674313840 | −5.6769253188297 |
| −3.042667 | −5.4572043918124 | 1.2297403614233 | −3.7726756252315 |
| −3.027333 | −2.9786165922325 | 1.2730453995524 | −1.2803659509964 |
| −3.012000 | 1.9585250330345 | 2.5450184342646 | 5.7269640795199 |
| −2.996667 | 7.8279830738474 | 4.5433867733877 | 3.3711425552708 |
| −2.981333 | 1.2902783583173 | 6.7633286365877 | 6.8041658410886 |
| −2.966000 | 1.2526742257698 | 6.1722219153226 | 9.1167589210556 |
| −2.950667 | 1.0018627096294 | 2.7394233638366 | 9.2786947936313 |
| −2.935333 | 1.0150844334248 | 5.2656791126665 | 5.5720093926980 |
| −2.920000 | 1.3407202007793 | 3.4660449736892 | 1.3306573195338 |
| −2.904667 | 1.7652262446776 | 1.0110204864139 | 1.7166475126885 |
| −2.889333 | 2.0070165782696 | 1.3965479817767 | 4.4766809145767 |
| −2.874000 | 1.8861341897324 | 1.1499364290727 | 7.6569102853124 |
| −2.858667 | 1.6218262570347 | 6.9932320625513 | 8.7986858056139 |
| −2.843333 | 1.5001759658766 | 9.9169404728607 | 7.4154022527106 |
| −2.828000 | 1.4518840049056 | 1.3844445464203 | 5.6303599104053 |
| −2.812667 | 1.4460957803561 | 1.3977100259347 | 4.7942693288721 |
| −2.797333 | 1.4293490385766 | 1.1995737404463 | 4.0769830407506 |
| −2.782000 | 1.2670205270439 | 3.9195472106150 | 4.2746020672763 |
| −2.766667 | 1.1558596600795 | 8.0823524730774 | 4.8099008692096 |
| −2.751333 | 1.1170051816753 | 7.2095703824217 | 5.6045098932236 |
| −2.736000 | 9.6381396924337 | 7.4425269936042 | 6.7184003098125 |
| −2.720667 | 5.9017105961768 | −1.1558968846850 | 7.3765068442433 |
| −2.705333 | 3.1110746619612 | −4.9252869932893 | 7.2319207799334 |
| −2.690000 | 2.0881428678988 | −2.0830822222383 | 5.5456489871417 |
| −2.674667 | 2.3344807167280 | 6.5208634406876 | 3.3593837935911 |
| −2.659333 | 3.4189880467535 | 9.6041033106235 | 2.2581567287635 |
| −2.644000 | 4.0372019813309 | 1.1343769175230 | 2.3196695791353 |
| −2.628667 | 4.2500573368288 | 1.6062373487142 | 4.1190944031809 |
| −2.613333 | 4.1723593782418 | 1.9414306442744 | 6.0462257336876 |
| −2.598000 | 3.9177605986905 | 1.7326481216423 | 6.0237775720172 |
| −2.582667 | 4.4135679863921 | 1.6109609017564 | 5.0936049533944 |
| −2.567333 | 5.9345182316617 | 1.7818037100756 | 4.5992788815982 |
| −2.552000 | 8.2816569493170 | 1.9060128037753 | 5.0164396511348 |
| −2.536667 | 1.0787373054832 | 2.3474017701146 | 5.8078710279555 |
| −2.521333 | 1.0689746633669 | 2.3199109038193 | 6.7437603375382 |
| −2.506000 | 8.6257224906142 | 1.5639304745074 | 7.8623487762577 |
| −2.490667 | 6.9027709719771 | 7.3912847170266 | 7.5906355993666 |
| −2.475333 | 5.8864974012868 | −2.0893790348843 | 4.3617034844048 |
| −2.460000 | 5.6477993441926 | −6.2104608555186 | 9.3561589079148 |
| −2.444667 | 5.4293697582236 | −1.4409198880025 | −1.5558620693527 |
| −2.429333 | 5.2689384892834 | 4.8616989281526 | −3.0618916144387 |
| −2.414000 | 4.8817961626023 | 9.3102848047296 | −3.5788978979904 |
| −2.398667 | 4.1594750729346 | 1.0984519286641 | −3.5261490562684 |
| −2.383333 | 2.4678817100450 | 9.4696040030241 | −3.8754993285694 |
| −2.368000 | 1.3115514472650 | 6.5228166994155 | −4.0591271826765 |
| −2.352667 | 1.6042044700692 | 3.7512111155832 | −5.4546302032983 |
| −2.337333 | −1.2982946868890 | −7.6368521972001 | −7.1654293001620 |
| −2.322000 | −2.5930313128403 | −1.7129615677025 | −7.9126776425248 |
| −2.306667 | −2.9632746110567 | −2.1763400969280 | −8.3106598256700 |
| −2.291333 | −2.8053049597201 | −1.2507231670178 | −9.0991362980359 |
| −2.276000 | −1.7756658744796 | 3.4399128369517 | −9.1430648516278 |
| −2.260667 | −1.1879964301340 | 1.1618988321748 | −8.9110598575755 |
| −2.245333 | −1.0776689459039 | 1.0927196897255 | −8.6426666154557 |
| −2.230000 | −1.4985273881143 | 5.9088914075657 | −8.0807019426129 |
| −2.214667 | −1.7469998906589 | 4.5100884907115 | −7.4540736149848 |
| −2.199333 | −1.6821690577876 | 6.4489245970523 | −7.8926580378031 |
| −2.184000 | −1.6461690086390 | 5.5687259514693 | −8.6631707128031 |
| −2.168667 | −1.7603375026553 | 3.6400177223842 | −8.6004147679885 |
| −2.153333 | −1.7568684780408 | 4.1184537223493 | −8.1242408542323 |
| −2.138000 | −2.8990885760365 | 3.8335000089103 | −8.3162369335442 |
| −2.122667 | −4.4496942859444 | −1.2018129625691 | −8.8357664923984 |
| −2.107333 | −5.8062471278058 | −9.4485456763803 | −1.0443837095532 |
| −2.092000 | −7.0350578889602 | −2.1490452916916 | −1.1803009643127 |
| −2.076667 | −8.6529173536251 | −3.9459276549621 | −1.0734525186757 |
| −2.061333 | −9.8583783858913 | −5.3276390707059 | −9.5872726719168 |
| −2.046000 | −9.7186543164276 | −5.4715044280044 | −1.0477576235112 |
| −2.030667 | −8.9118603957469 | −4.9644557741664 | −1.1854661496947 |
| −2.015333 | −7.6628932290409 | −3.9334391013444 | −1.3164665895632 |
| −2.000000 | −6.2984207986032 | −2.8379688261963 | −1.3705394367281 |
| −1.984667 | −4.1297011492005 | −1.8865982389178 | −1.0343576152167 |
| −1.969333 | −2.2791172627752 | −1.1957942769723 | −7.5422889293850 |
| −1.954000 | −1.6777874531966 | −9.7460185544481 | −6.3949704215857 |
| −1.938667 | −1.1922878190155 | −1.1057808602945 | −5.3411707453740 |
| −1.923333 | −6.4238632725653 | −9.3586651933816 | −4.4255579105374 |
| −1.908000 | −1.5982060466118 | −5.2224113005991 | −3.7640602456347 |
| −1.892667 | −2.7154064737500 | −5.5366527413881 | −2.9292118006434 |
| −1.877333 | −6.4772254116929 | −7.8683138537682 | −2.1394532153913 |
| −1.862000 | −4.2202499019316 | −5.5156431335176 | −2.0837995067466 |
| −1.846667 | −4.8633249181649 | −4.6327492426236 | −2.5014747243342 |
| −1.831333 | −1.3317441596444 | −1.0574643998140 | −2.9795292261812 |
| −1.816000 | −1.6521847245069 | −1.4798673512617 | −3.2151782619205 |
| −1.800667 | −1.1265802571020 | −9.6313560970545 | −3.1780780097260 |
| −1.785333 | −3.0706872548284 | −9.7234806690569 | −3.2949672571753 |
| −1.770000 | 6.3005913792022 | 3.9871538136962 | −2.8105129404554 |
| −1.754667 | 9.5270002959065 | 3.9044217651716 | −1.7947477549620 |
| −1.739333 | 3.6415088079720 | 3.3139070270169 | −1.2272544855657 |
| −1.724000 | 1.5504761482548 | 3.1671185671784 | −8.4754719769122 |
| −1.708667 | 2.5380425034384 | 2.0636253506055 | −1.1240321378611 |
| −1.693333 | 4.1018600248606 | 5.2598789993599 | −1.4886638602026 |
| −1.678000 | 5.6106738863728 | 3.0707437939646 | −1.6299407374708 |
| −1.662667 | 8.9389532882063 | 2.4327856729750 | −1.7820431733614 |
| −1.647333 | 1.2194663964067 | 7.1990106893102 | −1.5633387077642 |
| −1.632000 | 1.4589760361765 | 9.5541958988570 | −1.4165294897082 |
| −1.616667 | 1.0361651025658 | 3.6455559085267 | −1.4843498715024 |
| −1.601333 | 7.1726638493717 | −4.1159347757118 | −1.6928678290056 |
| −1.586000 | 2.6046887189940 | −7.6206675035211 | −2.3215852236716 |
| −1.570667 | −5.4113178487501 | −1.1899466341195 | −3.5895943853654 |
| −1.555333 | −2.1026569424834 | −2.0146899331094 | −3.7359309710016 |
| −1.540000 | −3.1147342932086 | −2.5618819136959 | −1.9616623156334 |
| −1.524667 | −3.5126983350517 | −2.3042905211994 | −1.5217925154525 |
| −1.509333 | −3.0892236789697 | −2.1717577071193 | −2.4976295399727 |
| −1.494000 | −3.1673044726786 | −2.4395303196475 | −4.3625583764482 |
| −1.478667 | −3.4163128743048 | −2.3759992126435 | −5.8477484947897 |
| −1.463333 | −4.6500585526974 | −1.9960927102380 | −5.6006424804196 |
| −1.448000 | −3.7491504283830 | −1.0214770347433 | −4.9482909728770 |
| −1.432667 | −4.5821944369893 | 2.6741737140049 | −4.5349685444756 |
| −1.417333 | 1.1298314737433 | 3.5313524594063 | −4.1034473619903 |
| −1.402000 | −1.4249405203420 | −6.3599102738319 | −2.4317312740426 |
| −1.386667 | −6.9819473979001 | −1.0297380445394 | −5.8132150815486 |
| −1.371333 | 4.7519296895258 | −2.1998247415249 | 2.5982257306209 |
| −1.356000 | 8.8827344511149 | 5.7106595380315 | 4.7824286072675 |
| −1.340667 | 1.6680844560755 | 1.4461856313308 | 1.2417699657659 |
| −1.325333 | 2.0306121059799 | 2.0122348214167 | −8.2041634888204 |
| −1.310000 | 8.5897128836439 | 1.1224192561532 | −5.7923346482062 |
| −1.294667 | −4.7499614523101 | −3.5980175864750 | −5.8890714672252 |
| −1.279333 | −1.1827470348807 | −1.3879798067800 | −2.3968981095466 |
| −1.264000 | −1.4961859838896 | −2.0336721384925 | −4.0167891194678 |
| −1.248667 | −1.6833278206010 | −1.8782351109423 | −5.4896940586817 |
| −1.233333 | −6.4986208874715 | −1.1786367841469 | −5.9165679151220 |
| −1.218000 | 8.4025959152174 | −4.9182051076404 | −4.7140011167423 |
| −1.202667 | 2.1360592802798 | 2.0224823520136 | −2.5062876468096 |
| −1.187333 | −1.0722110802241 | −7.7215675413422 | −2.4931435196256 |
| −1.172000 | −1.4289053542804 | −2.4463078195102 | −2.5154071192497 |
| −1.156667 | −9.5352677909871 | −3.2093464997454 | −1.2765568067774 |
| −1.141333 | 1.1786975231210 | −1.9874612438057 | −5.9554849575421 |
| −1.126000 | 2.5001517424612 | −6.1056812061898 | 7.4602733737834 |
| −1.110667 | 3.8798701990497 | 3.1776945513632 | 3.1178466111663 |
| −1.095333 | 4.4669754915161 | 1.1312720759589 | 1.8764094125568 |
| −1.080000 | 2.7770702516368 | 2.6495051355549 | −1.7438232305753 |
| −1.064667 | −9.3557035678042 | −1.2946031590818 | −4.0251969241963 |
| −1.049333 | −1.2339429991375 | −9.1432185070131 | −5.5498637168327 |
| −1.034000 | −1.5359664660576 | −1.6334034856219 | −7.4894692932084 |
| −1.018667 | 4.8948730116924 | −1.7244918286876 | −8.6437272795605 |
| −1.003333 | 5.5855736570995 | 1.2358224255674 | −8.5487752533261 |
| −0.988000 | 8.4535367674732 | 2.2783825880327 | −6.7592319809320 |
| −0.972667 | 1.0665418465995 | −8.2772781685700 | −6.7378717150511 |
| −0.957333 | −4.5068525120736 | −1.2732278776097 | −6.6919693411794 |
| −0.942000 | −2.5018355577639 | 8.9973501521966 | −1.0103910760742 |
| −0.926667 | −1.7330878987861 | 9.0638302260608 | −1.2533836654293 |
| −0.911333 | −5.0828802536539 | −1.1883519083477 | −7.2631405100351 |
| −0.896000 | 5.9036179167957 | −3.4322973276273 | −1.2223442971724 |
| −0.880667 | 9.8343735451398 | −3.4465751272038 | 3.7470277745102 |
| −0.865333 | 9.4299388210481 | 4.8271504465261 | 6.5310807928464 |
| −0.850000 | 5.4525917834582 | 1.2970727486303 | 7.4238434752724 |
| −0.834667 | −1.2131669879012 | 7.3157768550405 | 3.6381096358313 |
| −0.819333 | −5.0115140214333 | 8.4893531074127 | −2.4466347948671 |
| −0.804000 | −4.9746452206506 | 1.7653144321272 | −6.3987116922121 |
| −0.788667 | −4.8365143078281 | −1.0771113021171 | −1.0753356926958 |
| −0.773333 | −2.3742256476709 | −1.0767998427948 | −1.1074945379177 |
| −0.758000 | −4.0383556149128 | −4.8904512578659 | −1.1609675114968 |
| −0.742667 | −2.9921930440386 | 2.2895758313149 | 8.1400238810487 |
| −0.727333 | −7.5922376981440 | −7.2683738278207 | 3.2697974499232 |
| −0.712000 | −7.6476449647581 | −1.8249475295783 | −5.3429009024652 |
| −0.696667 | 1.3320209060763 | −1.7711020591473 | −1.1710690037743 |
| −0.681333 | 8.5375278328467 | −1.0923026981289 | −1.2877436228677 |
| −0.666000 | 5.6306038204437 | −2.0744052433288 | −5.0598440996286 |
| −0.650667 | −1.0782367171398 | −2.9968232628142 | 6.0104660356891 |
| −0.635333 | −2.8462832056063 | −7.9363359118317 | 7.2835983893814 |
| −0.620000 | −2.7673005848683 | 1.7369632890392 | 2.5329572579156 |
| −0.604667 | −2.1957887487552 | 2.3725202109339 | −2.5577283891861 |
| −0.589333 | −3.9507489796802 | 1.7062992857910 | −2.6068251726011 |
| −0.574000 | −6.3201290948512 | −9.9513323427372 | −6.0623342670567 |
| −0.558667 | −2.8614115745505 | −1.3919253301789 | −7.6596826404741 |
| −0.543333 | −2.1732995968512 | 1.2119312688831 | −4.3165160177293 |
| −0.528000 | −3.5908343439076 | 1.5754798141646 | −1.4513006554740 |
| −0.512667 | −1.0913907814644 | −1.0294245539532 | −8.2739286502476 |
| −0.497333 | −8.4578765344278 | −2.6267984576201 | −1.0853295939374 |
| −0.482000 | 4.3524223869086 | −1.0823174764618 | 2.7737076407016 |
| −0.466667 | 1.9542446045268 | 2.6081770121544 | 1.6340521817155 |
| −0.451333 | 2.5216602367639 | 4.8169931611402 | 2.3458780438126 |
| −0.436000 | 2.5730389352162 | 3.6786767355767 | 2.2168900413145 |
| −0.420667 | 2.0760659944844 | −3.4864875042429 | 1.8445196855352 |
| −0.405333 | 1.5670549396029 | −2.0549885853155 | 1.3787745905067 |
| −0.390000 | 1.8002792559011 | 2.4713904233463 | 8.1587936576831 |

TABLE 4b
Weights for connections from input nodes to last 3 hidden layer nodes

| Input node resonance | | | |
|---|---|---|---|
| frequency | Hidden node 4 | Hidden node 5 | Hidden node 6 |
| −4.300000 | 0.6300123527848 | −0.3337205727019 | −0.0766117582444 |
| −4.284666 | 0.8250000000000 | 1.1993236758095 | 8.5164015995404 |
| −4.269333 | 9.8256311857510 | 4.7360697477675 | 1.1095228619867 |
| −4.254000 | 9.0498556227729 | 5.5283340100545 | 3.4737464032418 |
| −4.238667 | 6.0995590077170 | 4.0679588933075 | −4.9256505595109 |
| −4.223333 | 2.6467661360041 | −9.2986719942063 | −1.2560855173232 |
| −4.208000 | 8.4719425403598 | −4.0478030320793 | −1.3367372847243 |
| −4.192667 | 1.8173840275725 | −2.8624288064326 | −2.4800501665381 |
| −4.177333 | 3.0114161225870 | 4.2413428212710 | 7.9239138855494 |
| −4.162000 | 3.6457652231174 | 6.9360596050089 | 1.0614563063218 |
| −4.146667 | 3.9915116646422 | 8.5616816688960 | 1.2612947857696 |
| −4.131333 | 3.1007860961112 | 6.7656033472129 | 1.0093645864772 |
| −4.116000 | 2.2053096937045 | 3.1368782790720 | 5.6217657097675 |
| −4.100667 | 2.7791631623684 | 1.7285526841199 | 8.0701353839281 |
| −4.085333 | 3.8239644116318 | 2.2140383166230 | 9.7580013206864 |
| −4.070000 | 3.4424650322203 | −2.0228005892999 | −3.5254635261796 |
| −4.054667 | 2.7267104239187 | −2.4821973814409 | −2.3357794016749 |
| −4.039333 | 2.6639283626657 | −7.8537402966576 | −2.6942564431523 |
| −4.024000 | 3.7845152600419 | 3.7140717710916 | −1.9299359108825 |
| −4.008667 | 7.2311989501369 | 1.2255215798513 | −4.6140134296849 |
| −3.993333 | 1.0034540029020 | 1.5841601569891 | 8.2971737221297 |
| −3.978000 | 7.8487382062849 | −2.6252098557026 | −6.1529473428799 |
| −3.962667 | 4.0770532061037 | −2.4826443799927 | −2.4239320748431 |
| −3.947333 | 5.0008684438474 | −1.8988611888979 | −8.8113539139454 |
| −3.932000 | 6.8011164241080 | −4.8904987589807 | 1.4755121081436 |
| −3.916667 | 6.3612561816339 | 6.1381941531096 | 1.7100589883564 |
| −3.901333 | 3.4731692773281 | 1.0244938702728 | 3.2547448715846 |
| −3.886000 | 1.3881017545067 | 8.2746195860994 | −9.4032914277638 |
| −3.870667 | 1.3628879690811 | 7.6549810058358 | −8.2388019642427 |
| −3.855333 | 1.8256776570451 | 1.4115596834942 | −1.0873569734548 |
| −3.840000 | 3.5792476975251 | 2.1027619889342 | −9.8802214388517 |
| −3.824667 | 9.0124587669827 | 2.6549706330295 | 1.1868816427283 |
| −3.809333 | 1.2837719593000 | 2.3974769843020 | 2.6459637384972 |
| −3.794000 | 1.1023828937212 | 1.4051334538365 | 3.7917875014655 |
| −3.778667 | 6.2023085134912 | 4.2131784998088 | −2.0111703575048 |
| −3.763333 | 1.7136704688208 | 1.6176017517445 | −1.5537773351284 |
| −3.748000 | −1.8914212148549 | −2.1052359527899 | −9.3815855588111 |
| −3.732667 | −4.1622677239314 | −5.7927225571985 | 8.4909385944862 |
| −3.717333 | −4.6766327755759 | −9.3819711930943 | 2.1723341783383 |
| −3.702000 | −7.1962120017379 | −1.7432561810288 | 2.4082112990063 |
| −3.686667 | −9.6087204247554 | −2.6878627664296 | 9.4677252852351 |
| −3.671333 | −1.3512777602912 | −3.2759160317385 | −2.0979616207458 |
| −3.656000 | −1.0366368413462 | −2.3080268165149 | −2.5451836927077 |
| −3.640667 | −4.2104718358547 | −6.3288953260795 | −1.1761601520260 |
| −3.625333 | 1.9196071610163 | 9.1291447554129 | −2.4687692665128 |
| −3.610000 | 1.2654561807133 | 1.6309866052963 | −4.4959946404800 |
| −3.594667 | −3.0686849737393 | 1.6169264991490 | −1.1399081258002 |
| −3.579333 | −1.1915808601975 | 9.2151096588347 | −8.3280014916094 |
| −3.564000 | 3.4237874174932 | 6.4201685663478 | −1.0072155798515 |
| −3.548667 | 5.8452493402137 | 1.7271504836076 | 2.3448506780674 |
| −3.533333 | 7.6921766419328 | 1.7256690189430 | 3.9151190750742 |
| −3.518000 | 3.1606265899042 | 4.2963001956032 | 6.2742946802932 |
| −3.502667 | −1.0879887569309 | −4.5910086575893 | −3.0282658412921 |
| −3.487333 | 2.8338942118189 | 5.1612995569395 | −1.9590627411720 |
| −3.472000 | 6.8491869900869 | 1.3442078715391 | 5.3962635993131 |
| −3.456667 | 3.0790649448135 | 1.1960603539102 | 1.0402001085144 |
| −3.441333 | −3.0687697674582 | 1.1303971063476 | 2.9384077340521 |
| −3.426000 | −6.1731223515716 | 9.7252308069836 | −5.9186806042240 |
| −3.410667 | −5.3643443419873 | 8.3107697252610 | −4.5411129419134 |
| −3.395333 | −2.9681716285378 | 1.4566070703369 | −1.3695372914954 |
| −3.380000 | −9.4610830960186 | 2.1176108324077 | −2.4652677297157 |
| −3.364667 | 6.2607975712825 | 2.3478658949993 | −2.0911233258247 |
| −3.349333 | 1.4868702724095 | 2.4097716661809 | −8.5600800893112 |
| −3.334000 | −2.7077487886689 | 2.6957967015478 | 2.1017009094098 |
| −3.318667 | −3.9027191473424 | 2.4139648598890 | 4.1292774226222 |
| −3.303333 | −9.3779347712182 | 1.2802652924908 | −3.4981678440611 |
| −3.288000 | −1.7301054606236 | −1.5447089670244 | −1.5436680488670 |
| −3.272667 | −2.6108389300109 | −2.3726139756305 | −2.7687868176422 |
| −3.257333 | −3.2104524071549 | −4.5558368748763 | −3.9582545845606 |
| −3.242000 | −3.9751148339373 | −6.8641954470543 | −5.9543334349627 |
| −3.226667 | −3.6521982312355 | −7.1828285215957 | −6.6571688261875 |
| −3.211333 | −3.2909162995438 | −6.9349496540423 | −7.9066212412905 |
| −3.196000 | −2.7826205210157 | −6.0407295604801 | −8.2434566967025 |
| −3.180667 | −2.2161018652280 | −4.7139078353188 | −6.8498206114517 |
| −3.165333 | −1.3401921322664 | −2.4799603694057 | −3.9624260303574 |
| −3.150000 | −5.3618743819430 | −2.7730229634655 | −1.5092273015485 |
| −3.134667 | −4.4901291025689 | 9.2347041192203 | 1.4264183956998 |
| −3.119333 | 2.8236553025125 | 1.0201813887400 | 1.6081351332523 |
| −3.104000 | 3.6441271343691 | 6.8147429089813 | 2.1591069394839 |
| −3.088667 | 1.2882698776397 | −3.5416340046284 | 1.3439184949793 |
| −3.073333 | −1.6552511950734 | −8.1720671483635 | 4.4218844040089 |
| −3.058000 | −3.1191202004688 | −1.2306928628496 | −5.4923617677154 |
| −3.042667 | −3.2034944120735 | −9.4357567527347 | −5.1146656165931 |
| −3.027333 | −3.8928327474281 | 2.9498700706082 | −7.0909747720571 |
| −3.012000 | 5.0158679432507 | 1.9401101807926 | −9.8001469435688 |
| −2.996667 | 1.1537027741952 | 3.4940767900328 | 1.8083582558456 |
| −2.981333 | 1.7125824914941 | 4.6003645452340 | 3.4030847546167 |
| −2.966000 | 1.6825638408414 | 4.2005043716781 | 1.9551088789879 |
| −2.950667 | 1.1921215420886 | 2.1306889355826 | −1.0466314619240 |
| −2.935333 | 1.0093138150158 | 6.0697402386097 | −1.8061019798324 |
| −2.920000 | 1.1077050293642 | 8.4695716768023 | −2.0793557590065 |
| −2.904667 | 1.2795839559311 | −6.4770258842086 | 7.2752733660113 |
| −2.889333 | 1.3060007125628 | −3.9711937735897 | 9.0144967335501 |
| −2.874000 | 1.1638385564518 | −5.5319618033492 | 1.0704857196584 |
| −2.858667 | 1.0206188206658 | −5.4220585718130 | 1.2657142011830 |
| −2.843333 | 1.0168158719020 | −1.3174054751864 | 1.6830073087971 |
| −2.828000 | 1.0247397139735 | 3.1645844988891 | 2.2427986517631 |
| −2.812667 | 1.1214042146235 | 7.5935654561656 | 2.6448547128211 |
| −2.797333 | 1.1838907340277 | 1.1543133804727 | 2.9056095906609 |
| −2.782000 | 1.0747729687991 | 1.0493816745832 | 2.5258632804837 |
| −2.766667 | 1.0210771367305 | 1.0822265515846 | 2.5994612804626 |
| −2.751333 | 1.2123275730438 | 2.0890800451901 | 3.8383384604370 |
| −2.736000 | 1.3364131813193 | 3.1772713908585 | 4.1800943573261 |
| −2.720667 | 1.0611762089801 | 3.1243345568304 | 2.4946482661875 |
| −2.705333 | 8.5585114786935 | 2.9631129710166 | 1.2768268986436 |
| −2.690000 | 8.2594257700156 | 3.0783825156772 | 1.3352563917094 |
| −2.674667 | 8.6652845368780 | 3.1785024914519 | 1.8262526064823 |
| −2.659333 | 1.0703355736794 | 3.6107318999282 | 2.2917569230477 |
| −2.644000 | 1.2231285881965 | 3.8552682560226 | 2.3405977067396 |
| −2.628667 | 1.1690871994601 | 3.4201169317787 | 1.8540628604831 |
| −2.613333 | 1.0578430424721 | 2.7898204944499 | 1.0524489606718 |
| −2.598000 | 9.3367555756135 | 2.1188797243216 | −3.6667073411804 |
| −2.582667 | 8.9252989411375 | 1.6500720363738 | −6.9766427783548 |
| −2.567333 | 9.5931118594670 | 1.4198224216862 | −8.0424025909042 |
| −2.552000 | 1.0694123145168 | 1.2953970981742 | −6.5075171775211 |
| −2.536667 | 1.1442808089591 | 1.4672346925569 | −2.9833680635971 |
| −2.521333 | 9.9801625981627 | 1.3017542487774 | −4.4446152487916 |
| −2.506000 | 7.0871102576609 | 8.0718541036058 | −1.5833074706696 |
| −2.490667 | 4.8994658419873 | 4.6875821173286 | −2.4367401941357 |
| −2.475333 | 3.2822417375950 | 9.0428109126455 | −2.1720226330882 |
| −2.460000 | 2.4159118918956 | −4.9028524026473 | −1.5003977579366 |
| −2.444667 | 2.2572001574668 | 3.5115604905365 | −8.2479026393754 |
| −2.429333 | 2.3165889307712 | 7.5722854799070 | −1.9866104849091 |
| −2.414000 | 1.7298910557359 | 1.1861838956778 | 7.5909789339243 |
| −2.398667 | 1.1332570792845 | 1.5164545072956 | 9.0538383627212 |
| −2.383333 | −2.4929795568696 | 1.6746919895507 | 1.8330670888897 |
| −2.368000 | −1.2616977174258 | 1.4971434943532 | 1.3935594850645 |
| −2.352667 | −2.0171573332512 | 1.1441163905045 | 8.7718888173773 |
| −2.337333 | −3.3809659506113 | 6.8004257264209 | −4.3746628357734 |
| −2.322000 | −5.0946197031072 | 9.2354168185614 | −1.0041431418565 |
| −2.306667 | −5.8588186458706 | −2.1252149909455 | −1.2371483619356 |
| −2.291333 | −5.4154635038673 | 1.8035611094626 | −7.3853200607889 |
| −2.276000 | −4.3675745005225 | 7.9352090897955 | 1.7691898791189 |
| −2.260667 | −3.7369710846883 | 1.0987185841605 | 1.0108894026907 |
| −2.245333 | −3.7669338686939 | 1.0621351302559 | 1.2787166309003 |
| −2.230000 | −4.4792614018218 | 7.9287536821236 | 7.2802200270407 |
| −2.214667 | −4.8329712593675 | 6.5657016523318 | 2.4139979625855 |
| −2.199333 | −4.5417116134056 | 6.9721055425284 | 2.1259562241301 |
| −2.184000 | −4.4782480204304 | 6.8801087088812 | 2.4014301928063 |
| −2.168667 | −4.5918500995074 | 5.3795901612535 | 4.1037688874488 |
| −2.153333 | −4.8186781987730 | 3.9260588698220 | 7.1459900892181 |
| −2.138000 | −5.8503420005837 | 1.6088614468075 | 6.7157356189645 |
| −2.122667 | −7.3068534076928 | −2.9912160289593 | 3.1549464306586 |
| −2.107333 | −8.7220976274004 | −8.8522786032263 | 7.9041070143133 |
| −2.092000 | −1.0351451547332 | −1.6035031056712 | −3.5657725257787 |
| −2.076667 | −1.2831535442581 | −2.6150761334935 | −1.6415158185813 |
| −2.061333 | −1.4556792401916 | −3.4872873500410 | −2.6915060338322 |
| −2.046000 | −1.4605966338987 | −3.5877610564067 | −2.4485911051536 |
| −2.030667 | −1.3473679431505 | −3.2204567016628 | −1.5645896765992 |
| −2.015333 | −1.2017096085773 | −2.5467621056020 | −4.8979012829797 |
| −2.000000 | −1.0384102148063 | −1.8623586055380 | 5.7643562674970 |
| −1.984667 | −7.5002760122547 | −1.2189335949012 | 1.1229413666327 |
| −1.969333 | −5.1355211214793 | −7.5996846809464 | 1.4311509997532 |
| −1.954000 | −4.0007471586939 | −6.2212306848748 | 1.4977256281089 |
| −1.938667 | −3.6191955075921 | −6.9540615941402 | 1.3189796833524 |
| −1.923333 | −2.6406018724519 | −5.5655657932439 | 1.3274488185836 |
| −1.908000 | −1.7500374231168 | −2.8047169959281 | 1.5314012956350 |
| −1.892667 | −1.7046067146331 | −2.4476282499582 | 1.3189347717886 |
| −1.877333 | −2.1796939220530 | −3.2636382659713 | 1.0163875080512 |
| −1.862000 | −1.9437726946225 | −2.6531487618219 | 1.2262031644742 |
| −1.846667 | −2.0294645531013 | −2.8363953586711 | 1.3053217694586 |
| −1.831333 | −3.0420645705163 | −5.8765227467385 | 7.6704267273321 |
| −1.816000 | −3.7686609728755 | −8.6196841883387 | 3.5944436481415 |
| −1.800667 | −3.2666514061430 | −6.5886449286019 | 6.6533355502838 |
| −1.785333 | −2.2405972998485 | −2.1481217408274 | 1.3178253463805 |
| −1.770000 | −1.4816089626589 | −2.0303417081962 | 1.4887708036610 |
| −1.754667 | −1.1872610589527 | −1.9821676001422 | 1.1485713244326 |
| −1.739333 | −9.2567904144543 | −8.1654388047198 | 8.1030446663455 |
| −1.724000 | −7.9033001084059 | −8.3535185981525 | 5.2102319962657 |
| −1.708667 | −6.9204634136113 | −2.6285861172785 | 3.2794931266813 |
| −1.693333 | −2.2034369584201 | 3.5413083139682 | 3.1000631540559 |
| −1.678000 | −1.1941484770991 | 6.4929717827270 | 4.1859386410599 |
| −1.662667 | 2.0737105104623 | 1.6252072308067 | 6.5033608856428 |
| −1.647333 | 7.9581435660783 | 3.8472732932422 | 9.5072745913908 |
| −1.632000 | 1.0682550121336 | 5.3290623472529 | 1.0242389564539 |
| −1.616667 | 5.3229023436125 | 3.7551836870786 | 5.1022004582258 |
| −1.601333 | −2.0252129648168 | 1.0600266693870 | −7.3721152814947 |
| −1.586000 | −9.7995664215665 | −1.6492696899234 | −2.8402455761129 |
| −1.570667 | −1.9056308994685 | −4.9473457052744 | −3.9882675836088 |
| −1.555333 | −3.5858886370116 | −9.2613700287805 | −1.0216615036877 |
| −1.540000 | −4.8181299457221 | −1.2532108467401 | −1.5724246545122 |
| −1.524667 | −4.9625752990391 | −1.2527497524161 | −1.3806328811316 |
| −1.509333 | −4.7989140325810 | −1.3617031558499 | −9.0250891127401 |
| −1.494000 | −5.1893620199162 | −1.4523346601186 | −6.4032553594350 |
| −1.478667 | −5.8795981899123 | −1.3543567156884 | −3.1974306076638 |
| −1.463333 | −7.7108357731298 | −1.4195362994572 | −3.8971238090787 |
| −1.448000 | −7.4354700612045 | −1.1932896479781 | −6.1259280270578 |
| −1.432667 | −3.3604178114117 | −1.5870391202550 | 1.2558282340972 |
| −1.417333 | −1.5275816115435 | 1.7487945060223 | 1.8436567814835 |
| −1.402000 | −2.6833032296312 | −3.6083219644512 | 1.1361395497453 |
| −1.386667 | −3.3320852860158 | −8.3384219976602 | 6.4909072193705 |
| −1.371333 | −2.4660671222079 | −6.1231129569693 | 8.6157639951612 |
| −1.356000 | −1.2599254779952 | −2.0165355863716 | 1.0858997524372 |
| −1.340667 | 9.5953460420774 | 1.7000549323662 | 1.5500041417544 |
| −1.325333 | 6.1964105356413 | 3.2211063735729 | 1.8792991383330 |
| −1.310000 | −6.5770980269022 | 4.5445023899319 | 1.1604214451837 |
| −1.294667 | −2.1201502932619 | −5.1029176405220 | 2.7676696207840 |
| −1.279333 | −2.9961768983785 | −9.8447492754027 | 6.7533343721997 |
| −1.264000 | −3.3777597325254 | −1.2065395881345 | −6.4384643095067 |
| −1.248667 | −3.2842240534382 | −9.1650736405010 | −1.3117091472074 |
| −1.233333 | −2.2701817556386 | −5.5369666749630 | 2.8482139193256 |
| −1.218000 | −1.8756343389606 | −4.8789061284524 | 6.5748747060126 |
| −1.202667 | −1.9263551508174 | −4.9601675131777 | 7.6003491989417 |
| −1.187333 | −2.8418688709590 | −6.9728525165086 | −1.3927184651528 |
| −1.172000 | −4.0971521611712 | −1.1654249317153 | −1.2475404323475 |
| −1.156667 | −4.0118628030739 | −1.2371523668182 | −1.8706739554271 |
| −1.141333 | −1.4864665641018 | −5.9286988642922 | −1.1064192569396 |
| −1.126000 | 1.4997881639416 | 3.0006186212833 | −3.5993432355608 |
| −1.110667 | 1.1904164614872 | 1.0162469843521 | 6.9697815939231 |
| −1.095333 | 1.3629830708317 | 1.4574285554560 | 2.9000164587148 |
| −1.080000 | −1.9277471640596 | 7.5668980418281 | 3.8708190660159 |
| −1.064667 | −6.3332140783458 | −3.7412621436819 | 2.4785297917990 |
| −1.049333 | −6.4029486889042 | −5.4833662655759 | 1.8066084552843 |
| −1.034000 | −6.0619221545456 | −3.0272244673033 | 3.4123019618507 |
| −1.018667 | −3.3606622210287 | −7.0671423723750 | −7.8123501006410 |
| −1.003333 | 3.6929021978687 | 1.3913787593749 | 6.9656781153127 |
| −0.988000 | 6.8920661851293 | 1.9391999539520 | 1.0808919471476 |
| −0.972667 | −2.1393116130310 | −2.4524623348518 | −2.2750764902352 |
| −0.957333 | −7.8801096965462 | −1.2599182482720 | −3.1637209545056 |
| −0.942000 | −4.7600054920239 | 5.8712688541352 | −5.6663961028544 |
| −0.926667 | −3.5488190125979 | 1.7166983698005 | −1.1337542172941 |
| −0.911333 | −3.0570274057506 | 1.3772861998924 | −6.3996374821459 |
| −0.896000 | 2.0042210830457 | 5.4772117434794 | 1.1005603237078 |
| −0.880667 | 3.6710490215257 | −2.4057137989387 | 8.1029970094637 |
| −0.865333 | 2.8572691075383 | −3.6348542197165 | −1.7267466699382 |
| −0.850000 | −4.4958286468936 | −4.8242383439030 | −1.5704806232562 |
| −0.834667 | −6.1478065358118 | −1.3113800287178 | −6.5537147366299 |
| −0.819333 | −1.0582225589142 | −2.1467269345661 | −1.7016786765060 |
| −0.804000 | −1.1662094995054 | −2.5875004423610 | −2.0261010448688 |
| −0.788667 | −1.2067416521806 | −2.2692290591609 | −1.3093294004068 |
| −0.773333 | −1.0778177090627 | −1.8627170165890 | 4.8184050122227 |
| −0.758000 | −1.4191569675347 | −2.7166822829227 | 9.3417386068104 |
| −0.742667 | −1.3874228673946 | −3.2107235320803 | 1.8743585049286 |
| −0.727333 | −1.8532828390556 | −3.9323289733550 | −1.6865897404838 |
| −0.712000 | −1.6391010813626 | −3.3495423832093 | −1.3603585185058 |
| −0.696667 | −4.7518967810218 | −1.3354381183973 | 1.9967471139228 |
| −0.681333 | 4.2071601072809 | 3.9220294269943 | 3.6847800407864 |
| −0.666000 | −5.2009817161374 | 2.7070799270902 | 1.8697607701729 |
| −0.650667 | −9.4194182722959 | −3.9679601755153 | −2.6691192768010 |
| −0.635333 | −1.2029004460638 | 1.2091993860128 | 9.3384182882595 |
| −0.620000 | −9.5574733786994 | 7.6320829716659 | 1.3850028921697 |
| −0.604667 | −8.7080719968814 | 5.1933026917883 | 5.0941349322184 |
| −0.589333 | −1.0086706250651 | −2.9917446517959 | −6.6071961476486 |
| −0.574000 | −1.2423753747248 | −1.7461738860492 | −2.5213975363525 |
| −0.558667 | −9.7202925076359 | −1.9944026671948 | −2.1334102888171 |
| −0.543333 | −8.6485185739904 | −8.0605124679512 | −3.2931636679899 |
| −0.528000 | −1.1126725683312 | −8.3630224296054 | 9.1004754889269 |
| −0.512667 | −1.7884643642083 | −2.2441120436587 | −1.4691912560870 |
| −0.497333 | −1.4652187228750 | −2.7242644596970 | −1.7895836018541 |
| −0.482000 | −1.8390585099661 | −8.0565232267535 | −1.5160346992942 |
| −0.466667 | 1.3197985033380 | 1.8455036064568 | 1.7496979855989 |
| −0.451333 | 1.8371845273408 | 2.4771118150403 | 2.2747076267393 |
| −0.436000 | 1.7842174028771 | 1.1960461093400 | 2.6784502487417 |
| −0.420667 | 1.1922383078578 | −1.3858338543372 | 1.6445245814022 |
| −0.405333 | 7.1592861016286 | −2.7405212191927 | −7.6222617793613 |
| −0.390000 | 1.1306854969267 | −7.2401930859907 | 3.7095920863923 |

TABLE 5
Weights for connections from hidden layer to output nodes.

| Hidden layer node | To output node 1 | To output node 2 |
|---|---|---|
| 1 | 0.787737917863234 | −0.819743247067499 |
| 2 | 2.347435656044930 | −2.305132859676630 |
| 3 | −4.360317067862270 | 4.326009299273890 |
| 4 | 0.229691664056358 | −0.123793291456329 |
| 5 | 1.795213106606780 | −1.905309222055490 |
| 6 | 6.154379614377560 | −6.172090111981210 |

TABLE 6
Biases for hidden layer and output nodes.

| | Bias |
|---|---|
| Hidden layer node | |
| 1 256 | 1.83667725131681 |
| 2 257 | 0.997618984551667 |
| 3 258 | 0.374253447232971 |
| 4 259 | 0.751779201878896 |
| 5 260 | −1.16519636266231 |
| 6 261 | 3.46988342822212 |
| Output layer node | |
| 1 262 | −1.18372776133975 |
| 2 263 | 1.20014583486794 |

It is anticipated that in some embodiments, the sensitivity of cancer detection by ANN models are improved by fusing MRI images with histo-pathological maps and using the precise locations of the tumor from the maps to inform the ANN about the locations of missed tumor voxels. It is also expected that higher accuracy can be attained in other embodiments by increasing the number of cases and to test and re-train the ANN models as more data becomes available.

### Hardware Overview

The processes and modules described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

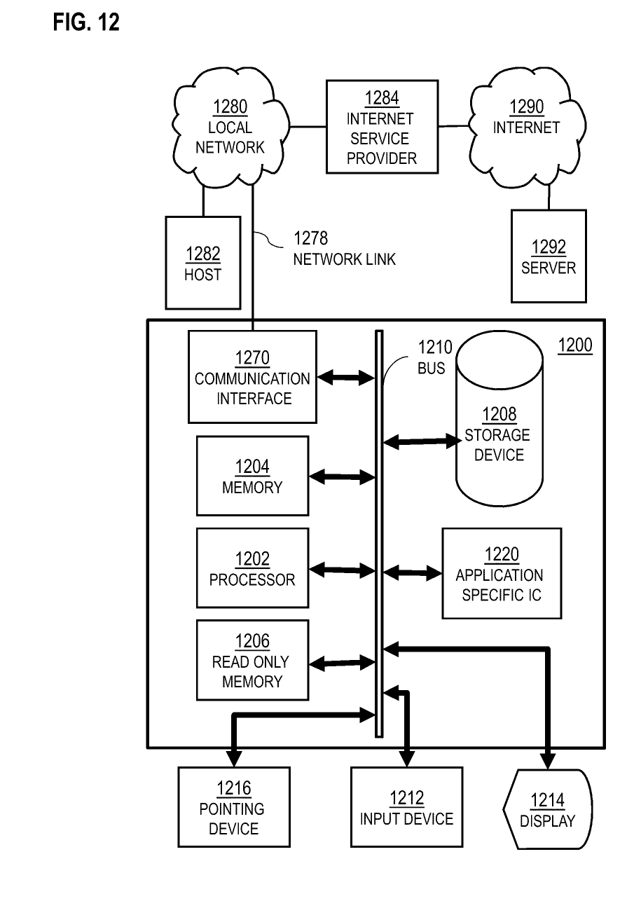

FIG. 12 illustrates a computer system 1200 upon which an embodiment of the invention may be implemented. Computer system 1200 includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1210 includes one or more parallel conductors of information so that information is transferred quickly among devices coupled to the bus 1210. One or more processors 1202 for processing information are coupled with the bus 1210.

A processor 1202 performs a set of operations on information. The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver.

The term computer-readable medium is used herein to refer to any medium that participates in providing information to processor 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290. A computer called a server host 1292 connected to the Internet hosts a process that provides a service in response to information received over the Internet. For example, server host 1292 hosts a process that provides information representing video data for presentation at display 1214.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining spectra for voxels from a first image obtained by hydrogen atom magnetic resonance spectroscopic imaging of a subject;
segregating the voxels by prostate anatomical zones;
deriving from the spectrum of each voxel in the zone, a plurality of input values for a neural network trained to classify a voxel as a tumor negative voxel or a tumor positive voxel in the anatomical zone for a training set comprising a plurality of images obtained by hydrogen atom magnetic resonance spectroscopic imaging of different subjects;
providing the plurality of input values to a processor configured as the neural network; and
automatically classifying each voxel based on output from the processor configured as the neural network.

2. A method of claim 1, wherein the prostate anatomical zones include a first zone anywhere outside the prostate gland and a second zone anywhere inside the prostate gland.

3. A method of claim 1, wherein the prostate anatomical zones include a first zone anywhere outside the prostate gland, a periurethral zone that includes a portion of the prostate gland adjacent to a urethra, a peripheral zone that encompasses a lower outer portion of the prostate gland, and a transition zone that includes a remainder of the prostate gland.

4. A method of claim 1, wherein deriving the plurality of input values for the neural network further comprises determining as the plurality of input values corresponding spectral amplitude values for a plurality of frequencies in a hydrogen atom magnetic resonance spectrum for the voxel.

5. A method of claim 4, wherein the plurality of frequencies include frequencies from about 4.3 parts per million (ppm) to about 0.4 ppm.

6. A method of claim 4, wherein the plurality of input values for the neural network comprises 256 inputs corresponding to 256 frequencies from about 4.3 parts per million (ppm) to about 0.4 ppm.

7. A method of claim 4, wherein deriving the plurality of input values for the neural network further comprises including in the plurality of input values a value indicating a prostate anatomical zone associated with the voxel, wherein the prostate anatomical zones include a first zone anywhere outside the prostate gland, a periurethral zone that includes a portions of the prostate gland adjacent to a urethra, a peripheral zone that encompasses a lower outer portion of the prostate gland, and a transition zone that includes a remainder of the prostate gland.

8. A method of claim 1, wherein the neural network comprises a hidden layer with a number of nodes between about four and about eight.

9. A method of claim 1, wherein at least fifty (50) percent of the time that the automatic classification classifies a voxel as tumor positive in a test set not used for training the neural network there is a tumor indicated by a histology section in a portion of the prostate gland corresponding to the voxel.

10. A method of claim 1, wherein at least seventy-five (75) percent of the time that the automatic classification classifies a voxel as tumor positive in a test set not used for training the neural network there is a tumor indicated by a histology section in a portion of the prostate gland corresponding to the voxel.

11. A method of claim 1, wherein the neural network is trained to classify a voxel as a tumor positive voxel if an experienced spectroscopist classifies the voxel as tumor suspicious based on the spectrum for the voxel.

12. A method of claim 1, wherein the neural network is trained to classify a voxel as a tumor positive voxel if a histology section indicates an actual lesion in a portion of the prostate gland associated with the voxel.

13. A method comprising:
determining spectra for voxels from a first image obtained by hydrogen atom magnetic resonance spectroscopic imaging of a subject;
segregating the voxels by prostate anatomical zone;
determining, for each voxel, the amplitudes of principal components in the anatomical zone, wherein the principal components are determined from a training set comprising a plurality of images obtained by hydrogen atom magnetic resonance spectroscopic imaging of different subjects;
providing the amplitudes as input to a processor configured to compute a functional form fit to classify a voxel as a tumor negative voxel or a tumor positive voxel of voxels in the zone for the training set; and
automatically classifying each voxel based on output from the processor configured to compute the functional form.

14. An apparatus comprising:
at least one processor; and
at least one memory including computer program code,
the at least one memory and the computer program code configured to, with the at least one processor, cause the apparatus to perform at least the following:
determine spectra for voxels from a first image obtained by hydrogen atom magnetic resonance spectroscopic imaging of a subject;
segregate the voxels by prostate anatomical zones;
derive from the spectrum of each voxel in the zone, a plurality of input values for a neural network trained to classify a voxel as a tumor negative voxel or a tumor positive voxel in the anatomical zone for a training set comprising a plurality of images obtained by hydrogen atom magnetic resonance spectroscopic imaging of different subjects;
provide the plurality of input values to a processor configured as the neural network; and
classify each voxel based on output from the processor configured as the neural network.

15. An apparatus comprising:
at least one processor; and
at least one memory including computer program code,
the at least one memory and the computer program code configured to, with the at least one processor, cause the apparatus to perform at least the following:
determine spectra for voxels from a first image obtained by hydrogen atom magnetic resonance spectroscopic imaging of a subject;
segregate the voxels by prostate anatomical zones;
derive, for each voxel, the amplitudes of principal components in the anatomical zone, wherein the principal components are determined from a training set comprising a plurality of images obtained by hydrogen atom magnetic resonance spectroscopic imaging of different subjects;
provide the amplitudes as input to a processor configured to compute a functional form fit to classify a voxel as a tumor negative voxel or a tumor positive voxel of voxels in the zone for the training s; and
classify each voxel based on output from the processor configured to compute the functional form.

16. A computer-readable storage medium carrying one or more sequences of one or more instructions which, when executed by one or more processors, cause an apparatus to at least perform the following steps:
determine spectra for voxels from a first image obtained by hydrogen atom magnetic resonance spectroscopic imaging of a subject;
segregate the voxels by prostate anatomical zones;
derive from the spectrum of each voxel in the zone, a plurality of input values for a neural network trained to classify a voxel as a tumor negative voxel or a tumor positive voxel in the anatomical zone for a training set comprising a plurality of images obtained by hydrogen atom magnetic resonance spectroscopic imaging of different subjects;
provide the plurality of input values to a processor configured as the neural network; and
automatically classify each voxel based on output from the processor configured as the neural network.

17. A computer-readable storage medium carrying one or more sequences of one or more instructions which, when executed by one or more processors, cause an apparatus to at least perform the following steps:
determine spectra for voxels from a first image obtained by hydrogen atom magnetic resonance spectroscopic imaging of a subject;
segregate the voxels by prostate anatomical zones;
derive, for each voxel, the amplitudes of principal components in the anatomical zone, wherein the principal components are determined from a training set comprising a plurality of images obtained by hydrogen atom magnetic resonance spectroscopic imaging of different subjects;
provide the amplitudes as input to a processor configured to compute a functional form fit to classify a voxel as a tumor negative voxel or a tumor positive voxel of voxels in the zone for the trainings; and
classify each voxel based on output from the processor configured to compute the functional form.

18. An apparatus comprising:
means for determining spectra for voxels from a first image obtained by hydrogen atom magnetic resonance spectroscopic imaging of a subject;
means for segregating the voxels by prostate anatomical zones;
means for deriving from the spectrum of each voxel in the zone, a plurality of input values for a neural network trained to classify a voxel as a tumor negative voxel or a tumor positive voxel in the anatomical zone for a training set comprising a plurality of images obtained by hydrogen atom magnetic resonance spectroscopic imaging of different subjects;
means for providing the plurality of input values to a processor configured as the neural network; and
means for classifying each voxel based on output from the processor configured as the neural network.

19. An apparatus comprising:
means for determining spectra for voxels from a first image obtained by hydrogen atom magnetic resonance spectroscopic imaging of a subject;
means for segregating the voxels by prostate anatomical zone;
means for determining, for each voxel, the amplitudes of principal components in the anatomical zone, wherein the principal components are determined from a training set comprising a plurality of images obtained by hydrogen atom magnetic resonance spectroscopic imaging of different subjects;
means for providing the amplitudes as input to a processor configured to compute a functional form fit to classify a voxel as a tumor negative voxel or a tumor positive voxel of voxels in the zone for the training set; and
means for classifying each voxel based on output from the processor configured to compute the functional form.
